(19) United States
(12) Patent Application Publication
(10) Pub. No.: US 2024/0288695 A1
(43) Pub. Date: Aug. 29, 2024

(54) HOLOGRAPHIC OPTICAL ELEMENT VIEWFINDER

(71) Applicant: META PLATFORMS, INC., Menlo Park, CA (US)

(72) Inventors: Brandon Michael Hellman Friedman, Redmond, WA (US); Brian Wheelwright, Sammamish, WA (US); Kavous Jorabchi, Bellevue, WA (US)

(21) Appl. No.: 18/627,366

(22) Filed: Apr. 4, 2024

Related U.S. Application Data
(63) Continuation-in-part of application No. 18/589,004, filed on Feb. 27, 2024.
(60) Provisional application No. 63/487,443, filed on Feb. 28, 2023.

(51) Int. Cl. G02B 27/01; G02B 27/42

(52) U.S. Cl. CPC G02B 27/0172; G02B 27/425; G02B 2027/0174

(57) ABSTRACT

A system and method for generating an eye box, an observable virtual image, and/or a multiplexed hologram are provided. The system may include a transparent combining optic including a holographic optical element. The transparent combining optic may be configured to diffract light received at a first side of the transparent combining optic. The light may be generated by an illumination source. The transparent combining optic may also be configured to form a virtual image viewable from a non-pupil-forming eyebox. The observable virtual image may be viewable from the first side of the transparent combining optic.

### CROSS-REFERENCE TO RELATED APPLICATIONS

This application is a continuation-in-part of U.S. patent application Ser. No. 18/589,004 filed on Feb. 27, 2024, and claims the benefit of U.S. Provisional Application No. 63/487,443 filed Feb. 28, 2023, the entire content of which is incorporated herein by reference.

### TECHNOLOGICAL FIELD

Examples of the present disclosure relate generally to systems, methods, apparatuses, and computer program products for utilizing holographic optical elements and generating observable virtual images.

### BACKGROUND

Augmented reality (AR) is a form of reality that has been adjusted in some manner before presentation to a user, which may include, e.g., a virtual reality (VR), an augmented reality (AR), a mixed reality (MR), a hybrid reality, or some combination and/or derivatives thereof. AR, VR, MR, and hybrid reality devices often provide content through visual means, such as through a headset or glasses.

Many augmented reality devices utilize displays to present information, render additive information and/or content on top of the physical world, and execute various AR operations and simulations. For example, an augmented reality device may display a virtual image overlaid on top of objects in the real world.

Smart devices, such as wearable technology and AR glasses may include a camera and a display. Given the camera capability, the device users may want to capture a photo. In some cases, the device may provide a viewfinder shown within the display field of view that allows the user to visualize the composition of the photo or video frame to be captured. If the display is used as the viewfinder, there is often a significant power requirement since camera data may be processed through a graphics pipeline and sent to a driving display. The user experience is often poor, especially when the display provides a low-resolution thumbnail much smaller than a full captured field of view (FOV), and likely partially see-through in an instance in which the display has low brightness without occlusion. These challenges are similar to those faced when attempting to capture photos with a phone or camera device, and may not directly view the events, since they are looking at the tiny display rather than the event or subject they intend to capture.

In addition, waveguide displays are generally more limited in the field of view compared to the camera (e.g., a display FOV of 30 degrees (deg.), camera FOV of 50 deg.), as well as in resolution. Some AR displays, like liquid crystal on silicon (LCOS), liquid crystal display (LCD) or digital micromirror device (DMD), may require full illumination, even if only a small segment of the field of view holds content. These displays are typically inefficient in showing extremely sparse content, like only a clock in the corner of the field of view, and generally require a significant power draw. Accordingly, improved techniques are needed to address present drawbacks.

### BRIEF SUMMARY

In meeting the described challenges, examples of the present disclosure provide systems, methods, devices, and computer program products utilizing holographic optical elements (HOEs) and producing observable virtual images. Various examples may include a transparent combining optic comprising a holographic optical element (HOE). The transparent combining optic may be configured to diffract light received at a first side of the transparent combining optic. The transparent combining optic may also be configured to diffract light to form a virtual image viewable from a non-pupil-forming eyebox. The virtual image may be viewable from the first side of the transparent combining optic.

In an example of the present disclosure, the virtual image may include at least one of: content defined by a distribution of the illumination source, or content defined by an encoding of the HOE. The HOE may include at least one of: a point-source hologram, an etendue expansion hologram, a set of multiplexed holograms, a layered stack of multiple holograms, or a patterned array of multiple holograms. The HOE may also include a point of illumination. The illumination source may be positioned at the point of illumination. In another example, light propagates through the point of illumination.

In another example, the illumination source may include an array of illumination sources. Light from the illumination source may propagate through at least one of: the transparent combining optic before being diffracted by the HOE, or free-space between the illumination source and the transparent combining optic. In an example, a head-mounted device includes the illumination source and the transparent combining optic. The illumination source may be positioned outside of a field of view of a user wearing the head-mounted device.

Various examples may also include a transparent combining optic configured to diffract an object beam on a first side of the transparent combining optic. The transparent combining optic may also be configured to diffract a reference beam received at a second side of the transparent combining optic. The transparent combining optic may also be configured to combine the reference beam and the object beam to generate an eye box and an observable virtual image within the eye box. The observable virtual image may be viewable from the first side of the transparent combining optic. The object beam may be generated by an illumination source and the reference beam may be associated with a scene viewable through the transparent combining optic and/or another light source.

In an example of the present disclosure the transparent combining optic may be a photosensitive holographic film. The transparent combining optic may also include an optical element positioned on the second side, to refine an optical property of the reference beam. The optical element may include at least one of a diffuser, a micro lens array, and a mask. The optical property may also include at least one of: spatial filtering, beam shaping, and exposure. In another example, the transparent combining optic may generate a multiplexed hologram. The illumination source may include one or more extended sources, one or more point sources, and other types of light sources. The illumination source may be positioned on a head mounted device, such as a frame of the head mounted device. The illumination source may be positioned outside of a field of view of a user wearing the head mounted device. The observable virtual image may also be positioned to overlay a scene viewable through the transparent combining optic.

In one example of the present disclosure, a method may be provided. The method may include diffracting an object beam received at a first side of a transparent combining optic. The transparent combining optic may include a holographic optical element. The object beam may be generated by an illumination source. The method may further include diffracting a reference beam received at a second side of the transparent combining optic. The method may further include combining the reference beam and the object beam to generate an eye box and an observable virtual image within the eye box. The observable virtual image may be viewable from the first side of the transparent combining optic. The object beam may be generated by an illumination source.

The method may further include expanding the eye box by combining, via the transparent combining optic, a second object beam from a second illumination source. The method may also include multiplexing, via the transparent combining optic, a second object beam from a second illumination source, and generating a second observable virtual image positioned to overlay a scene. As discussed herein, the illumination source may be secured to, or mounted within, a frame of a head-mounted device, such as a headset.

In another example of the present disclosure, a computer program product is provided. The computer program product may include at least one non-transitory computer-readable medium including computer-executable program code instructions stored therein. The computer-executable program code instructions may include program code instructions configured to emit an object beam from an illumination source towards a first side of a transparent combining optic including a holographic optical element. The computer program product may further include program code instructions configured to facilitate diffraction of the object beam received at the first side and a reference beam received at a second side of the transparent combining optic, to generate an eye box and an observable virtual image within the eye box. The observable virtual image may be viewable from the first side of the transparent combining optic.

The computer program product may further include program code instructions configured to emit a second object beam from a second illumination source towards the first side of the transparent combining optic to generate a multiplexed hologram. The computer program product may further include program code instructions configured to facilitate positioning of the observable virtual image to overlay a scene viewable by or through the transparent combining optic. The observable virtual image may also be updated using an etendue expansion convolution. As discussed herein, the illumination source may, for example, be a point source or an extended source.

Various examples may include at least one illumination source emitting light, and a transparent combining optic comprising a holographic optical element. The light emitted from the illumination source may illuminate the transparent combining optic, including the holographic optical element, and the transparent combining optic may diffract the light to generate an observable virtual image. The observable virtual image may be positioned to overlay a scene viewable through the transparent combining optic. In some examples, the transparent combining optic, including the HOE, may diffract the light to project the observable virtual image on a display.

In some examples of the present disclosure, the illumination source may include a plurality of illumination sources, such as for example a variable illumination source or an array of illumination sources separated spatially and/or differing in spectrum. Illumination sources may separately emit light to illuminate the HOE, and in some examples, a first illumination source and a second illumination source may project different images when diffracted by the HOE.

As discussed herein, the display which may present the observable virtual image, caused by the HOE diffracting the light and projecting the observable virtual image, may be included on a wearable system, such as a head-mounted display system. In some examples of the present disclosure, the head-mounted display system is at least one of a headset, glasses, helmet, visor, gaming device, or a smart device. The display may form part or all of one or more lenses, such as one or more lenses on a glasses frame. As such, the observable virtual image projected by the display may provide a virtual image that may be observed by a user wearing the glasses. In some examples, a plurality of observable virtual images may be provided on the display. One or more images may be selectable, and include, for example, a time, a letter, a number, a shape, or an icon. At least one of the observable virtual images may be selectable. For example, when used with an eye tracking system, information indicative of a user focusing on or looking at the observable virtual image may cause one or more actions to be taken. Such action may include, for example, taking an image of a scene captured by one or more cameras associated with the system, selecting an icon (e.g., opening up an application or feature associated with the icon, etc.), and/or the like.

Various systems, methods, devices, computer program products and examples of the present disclosure may include at least one camera capturing a scene, wherein an observable virtual image is associated with and/or highlights/represents or projects a section of the scene captured by the camera (e.g., a border indicating the region of capture). An eye tracking system may track at least one eye viewing the scene, may determine a region of the scene corresponding to the tracked eye movement, and may update the observable virtual image to highlight/represent and/or project the region of the scene. The region may then be captured in a photograph/image and/or a video.

In some additional examples of the present disclosure, the illumination may include a first illumination source and a second illumination source separately emitting light, a multiplexed HOE, and a plurality of observable virtual images projected on the display. In other examples, the illumination source may be a variable illumination source, the HOE may be multiplexed, and at least one of the plurality of observable virtual images may be selectable.

Additional advantages will be set forth in part in the description which follows or may be learned by practice. The advantages may be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings examples of the present disclosure; however, the disclosed subject matter is not limited to the specific methods, compositions, and devices disclosed. In addition, the drawings are not necessarily drawn to scale. In the drawings:

FIG. 1A illustrates an example holographic optical element system, in accordance with various aspects discussed herein.

FIG. 1B illustrates an example holographic optical element system with a waveguide illumination, in accordance with various aspects discussed herein.

FIG. 1C illustrates another example holographic optical element system with a waveguide illumination, in accordance with various aspects discussed herein.

FIG. 2 illustrates another example of display with an observable virtual image, in accordance with various aspects discussed herein.

FIG. 3A illustrates a viewfinder display in accordance with various aspects discussed herein.

FIG. 3B illustrates another example of a viewfinder display in accordance with various aspects discussed herein.

FIG. 4 illustrates various observable virtual images, in accordance with various aspects discussed herein.

FIG. 5 illustrates a flowchart for producing observable virtual images in accordance with various aspects discussed herein.

FIG. 6A illustrates an example hologram geometry in accordance with various aspects discussed herein.

FIG. 6B illustrates an example multiplexed hologram geometry in accordance with various aspects discussed herein.

FIG. 6C illustrates an example extended source hologram geometry in accordance with various aspects discussed herein.

FIG. 6D illustrates an example non-pupil forming hologram geometry in accordance with various aspects discussed herein.

FIG. 6E illustrates an example pupil forming hologram geometry in accordance with various aspects discussed herein.

FIG. 7A illustrates another example hologram geometry in accordance with various aspects discussed herein.

FIG. 7B illustrates another example multiplexed hologram geometry in accordance with various aspects discussed herein.

FIG. 7C illustrates an example extended source hologram geometry in accordance with various aspects discussed herein.

FIG. 8A illustrates an example point source hologram convolution in accordance with various aspects discussed herein.

FIG. 8B illustrates an example multiplexed hologram convolution in accordance with various aspects discussed herein.

FIG. 8C illustrates an example point source etendue expansion in accordance with various aspects discussed herein.

FIG. 8D illustrates an example extended source etendue expansion in accordance with various aspects discussed herein.

FIG. 9A illustrates a flow chart for generating an eye box and hologram in accordance with various aspects discussed herein.

FIG. 9B illustrates a flow chart for generating a virtual image in accordance with various aspects discussed herein.

FIG. 10 illustrates an augmented reality system comprising a headset, in accordance with various aspects discussed herein.

FIG. 11 illustrates a block diagram of an example device in accordance with various aspects discussed herein.

FIG. 12 illustrates a block diagram of an example computing system in accordance with various aspects discussed herein.

FIG. 13 illustrates a machine learning and training model in accordance with various aspects discussed herein.

FIG. 14 illustrates a computing system in accordance with various aspects discussed herein.

The figures depict various examples for purposes of illustration only. One skilled in the art will readily recognize from the following discussion that alternative examples of the structures and methods illustrated herein may be employed without departing from the principles described herein.

### DETAILED DESCRIPTION

The present disclosure may be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the claimed subject matter.

Some examples of the present disclosure will now be described more fully hereinafter with reference to the accompanying drawings, in which some, but not all examples of the present disclosure are shown. Indeed, various examples of the present disclosure may be embodied in many different forms and should not be construed as limited to the examples set forth herein. Like reference numerals refer to like elements throughout. As used herein, the terms “data,”“content,”“information” and similar terms may be used interchangeably to refer to data capable of being transmitted, received and/or stored in accordance with examples of the invention. Moreover, the term “exemplary”, as used herein, is not provided to convey any qualitative assessment, but instead merely to convey an illustration of an example. Thus, use of any such terms should not be taken to limit the spirit and scope of examples of the present disclosure.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional virtual worlds, online games (e.g., video games), one or more content items such as, for example, images, videos, non-fungible tokens (NFTs) and in which the content items may, for example, be purchased with digital currencies (e.g., cryptocurrencies) and/or other suitable currencies. In some examples, a Metaverse or Metaverse network may enable the generation and provision of immersive virtual spaces in which remote users may socialize, collaborate, learn, shop and engage in various other activities within the virtual spaces, including through the use of Augmented/Virtual/Mixed Reality.

References in this description to “an example”, “one example”, or the like, may mean that the particular feature, function, or characteristic being described is included in at least one example of the present invention. Occurrences of such phrases in this specification do not necessarily all refer to the same example, nor are they necessarily mutually exclusive.

Also, as used in the specification including the appended claims, the singular forms “a,”“an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. It is to be understood that the terminology used herein is for the purpose of describing particular aspects only and is not intended to be limiting.

It is to be appreciated that certain features of the disclosed subject matter which are, for clarity, described herein in the context of separate embodiments, may also be provided in combination in a single embodiment. Conversely, various features of the disclosed subject matter that are, for brevity, described in the context of a single embodiment, may also be provided separately or in any sub-combination. Further, any reference to values stated in ranges includes each and every value within that range. Any documents cited herein are incorporated herein by reference in their entireties for any and all purposes.

In various aspects, systems, methods, devices, and computer program products utilize holographic optical element (HOE) to produce observable virtual images. The techniques and aspects discussed herein differentiate and improve upon conventional systems, at least by eliminating pixelated displays, and providing unique methods for providing virtual observable images, on various systems, such as for example wearable technology, smart glasses, and other head-mounted display systems. The HOE-based projection systems, methods, devices, and computer program products further provide improved, and optionally selectable and interactive visualizations, thereby providing an enhanced user experience and enhanced capabilities.

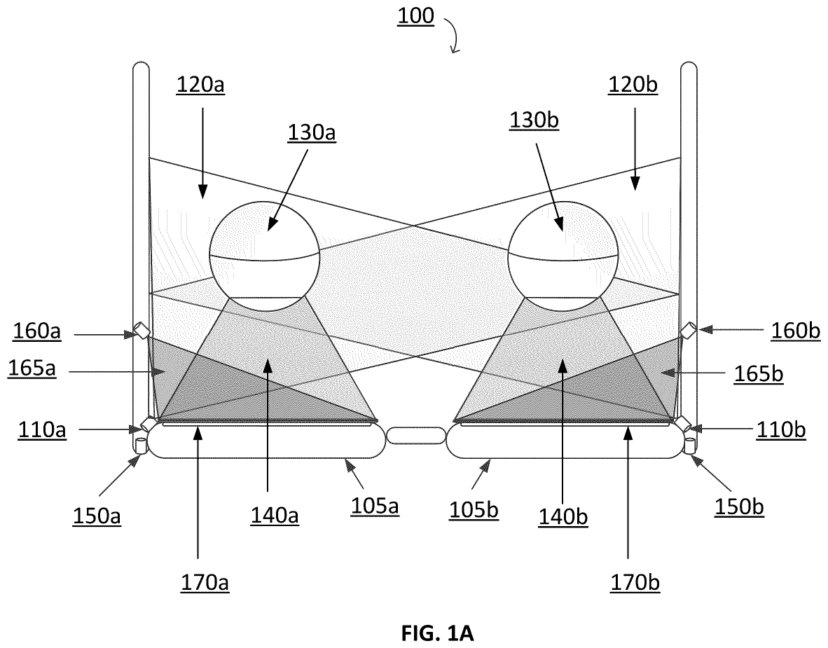

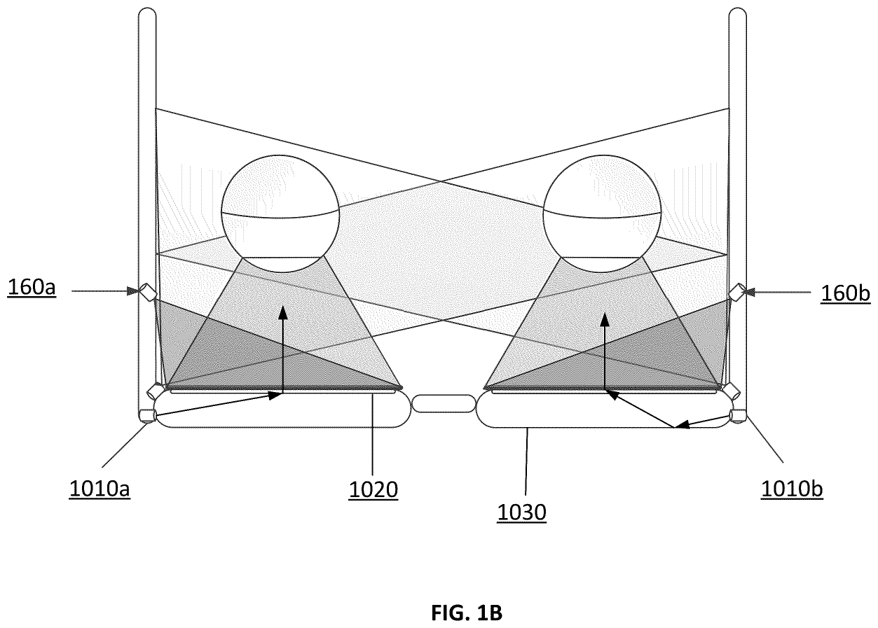

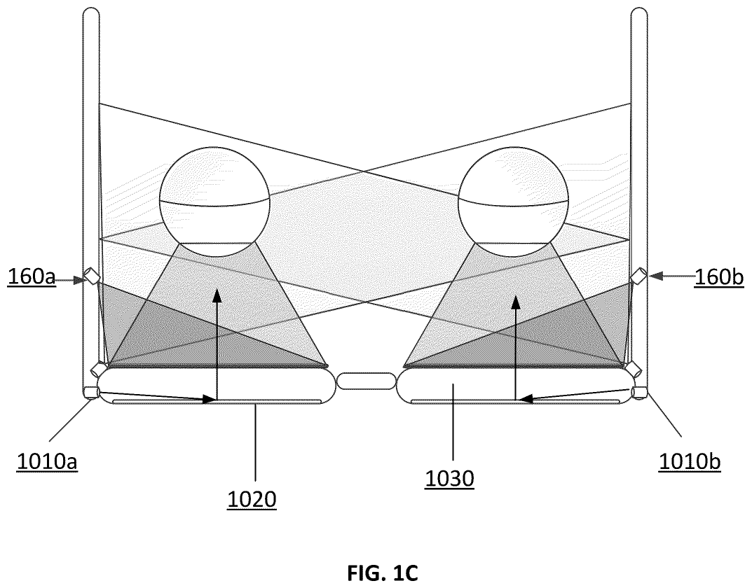

FIG. 1A illustrates an example implementation of HOE-based system in accordance with aspects discussed herein. FIG. 1A illustrates a plan view of an example system including system 100, on which various techniques may be applied. In some examples, the system 100 may be utilized in a Metaverse network. In other examples, the system 100 may be utilized in any suitable network capable of provisioning content and/or facilitating communications among entities within or associated with the network. In some examples, the system 100 may include an AR/VR glasses headset. It should be appreciated that the various sensors and techniques may be applied to a range of applications, including but not limited to other head-mounted devices, headsets, helmets, visors, gaming devices, smart devices, and other wearable technology, including glasses that do not include digital pixelated displays.

A Holographic Optical Element (HOE) 170a, 170b may be placed on a lenses 105a, 105b (also referred to herein as lens system(s) 105a, 105b) or a waveguide of the system 100 (e.g., AR smart glasses). A corresponding illumination source (e.g., a laser, a light emitting diode (LED), etc.) located on the glasses (e.g., illumination source 160a, 160b) illuminates the HOE over a projection frustum 165a, 165b which may uniformly or non-uniformly illuminate the HOE according to the design. The recording within the HOE receives light from projection frustums 165a, 165b and diffracts or redirects this light into particular angles toward the user's eyes 130a, 130b, delivering a static virtual image. This static virtual image may subtend a significantly larger angle than any dynamic display incorporated into lenses 105a, 105b, such as a waveguide display.

It should be appreciated that the static projection is not limited by the field of view of a waveguide. The HOE may include multiple HOEs and the illumination source may be an illumination system including multiple illumination sources or a variable illumination source. Each different illumination source, or variable source mode, may project a different static image (e.g., multiplexing across sources and HOEs). Various types of HOEs, including but not limited to multiplexed HOEs, may be compatible with system 100, glasses, smart glasses, glasses with AR displays, and various combinations discussed herein, whether the AR display is waveguide-based or uses another AR combining architecture.

According to some aspects, the HOE may be transparent and placed on glass, e.g., lens 105. The HOE may include many layers or many exposures, each layer or exposure is multiplexed to a unique illumination trait. Different or changing sources “turn on” each projection. For example, a first color source (e.g., a green source) illuminating the HOE may “turn on” the rectangular box line viewfinder showing the photo field of view (FOV) (e.g., 60×80 degrees). A second color source (e.g., a red source) may “turn on” a different size rectangular box showing the video FOV (e.g., 40×40 deg). Accordingly respective observable images may be generated from separate illumination sources.

In various examples, HOE multiplexing may be in any wavelength, polarization, angle, or any other know optical multiplexing technique. Many types of HOEs may be utilized including Volume Bragg Grating (VBG), Polarization Volume Holograms (PVH), Surface Relief Gratings (SRG), meta surface, etc. LED illumination could be used by a broadband HOE, or by multiple exposures at different wavelengths within an LED to increase the effective bandwidth to match the LED.

In various examples, as illustrated in FIG. 1A, right eye 130a and left eye 130b may be positioned behind a respective lens system, e.g., right lens 105a and left lens 105b. The lens system may be configured to provide a visual display. A right eye sensor system 110a may capture a field of view 120a which includes the right eye 130a, and track movements of the right eye. A left eye sensor system 110b may capture a field of view 120b which includes the left eye 130b, and track movements of the left eye. In some instances, one or both sensor systems, e.g., 110a, 110b, may have a field of view which includes one or both eyes. In some examples, eye tracking information for one or both eyes, captured by a single sensor system may be used. In other examples, a sensor system may focus on a single eye, even if both eyes are within its field of view. Variations and combinations or sensor information and eye information may be adjusted based on a type of sensor desired information, and other application characteristics and factors, including but not limited to latency, power consumption, accuracy, and the like.

In various examples, the sensor systems may be positioned outside of a field of view of an eye, particularly, the eye which is being tracked by the sensor. As illustrated in FIG. 1A, right eye sensor system 110a is positioned outside of the right eye field of view 140a, and left eye sensor system 110b is positioned outside of the left eye field of view 140b. Such positioning prevents obstruction, distraction, and other discomfort or annoyance which may arise with the sensor system being within an eye's field of view. Such positioning further enables seamless operation, and in some cases, presentation of visual content on a lens system 105a, 105b.

The right eye sensor system 110a may track the right eye 130a using a first tracking method, and the left eye sensor system 110b may track the left eye 130b using a second tracking method different from the first sensor system. In various examples, the tracking may be visual tracking, for example, using a camera, photosensor oculography (PSOG), event-based tracking, which may occur in real-time, range imaging, and time of flight techniques, including indirect time of flight (iTOF) techniques, among others.

The tracked eye movement information from both eyes may be processed via a computing system including a processor and non-transitory memory. The computing system and processing may occur locally, remotely, or both, with some processing operations happening locally and others remotely. Remote processing may occur over network, via a cloud computing network as discussed herein, or via one or more servers, devices, and systems in remote network communication with the system 100.

The tracked eye movements from the left and right eye may be correlated to determine a gaze motion pattern, which may be a three-dimensional gaze motion pattern. Correlating tracking information may include determining a convergence pattern or divergence pattern based on the tracked movement of both eyes. Such convergence and divergence patterns may indicate whether an eye is focusing on something near or far. Based on that contextual information, the gaze motion pattern may be determined to be a two-dimensional or three-dimensional gaze motion pattern.

In various examples, at least one sensor system 150a, 150b may capture a scene. The sensor system 150a, 150b may include a camera, and/or be outward facing. The sensory system 150 may capture a live scene, similar to the live scene observed by the eyes 130. In examples, the sensor system 150 may be embedded within, placed upon, or otherwise affixed or secured to the glasses frame. The sensor system 150 may capture a scene, and the observable virtual image may project at least a portion of the scene onto the display system. As such, the tracked eye movements may be utilized to determine a region of the scene corresponding to the tracked eye movements, and the observable virtual image may be updated to display the region of the scene. Such scene information may be utilized to determine one or more observable virtual images to display, as well as optionally determining a position of the virtual image (e.g., not blocking an area of interest within the scene or where the eyes are looking, etc.).

In various examples, respective sensor systems determine a motion pattern based on the tracked eye movements. The two motion patterns, i.e., from each eye, may be combined to determine a gaze motion pattern, indicative of where the user is looking and focusing. Such motion pattern identification and gaze determinations may occur in real-time, and/or with very minimal (e.g., a millisecond or less) latency. In certain AR/VR applications, such as gaming, or operation of smart glasses, such speeds may be crucial for a seamless and satisfying experience using the product. For example, a visual display may provide content, such as pictures, video, text, animations, etc., on a lens system (e.g., lens systems 105a, 105b). Such content may be shifted, selected, interacted with, or responsive to a gaze. Thus, fast and accurate eye tracking may be necessary to enable such interactions. Therefore, in some aspects, the determined gaze pattern, from the correlated eye tracking data, may cause a visual display to project visual content in response to the determined gaze pattern. The heterogeneous nature of the two sensor systems further enables such interactions and interactions with improved speed, power consumption, latency, and other characteristics, as discussed herein.

As one example, a camera may have a dense image information, thus being able to achieve high accuracy. However, such camera's power consumption may be very high. An iTOF sensor could achieve lower power consumption, but its accuracy may be low. Therefore, a camera may track one eye, and an iTOF sensor may track the other eye. Then, the information between two eyes may be correlated, and the two measurements fused together to achieve a high accuracy measurement, with a lower overall power consumption than a two-camera solution, and higher accuracy than a two iTOF sensor solution.

As another example, FIGS. 1B and 1C illustrate various illumination system and waveguide placements for HOE-based technologies as discussed herein. In FIGS. 1B and 1C, illumination systems 1010 are provided in a frame, such as a glasses frame. The illumination system 1010 may include one or more illumination sources (e.g., illumination source 160a, illumination source 160b) for a hologram. The illumination generated by the one or more illumination sources of the illumination system 1010 may propagate from the illumination system 1010 through a waveguide combiner to generate a hologram. The illumination system may create a light path that travels through a waveguide and an HOE to illuminate a hologram. In examples, after the waveguide propagation and hologram diffraction, the light may be directed from the HOE and waveguide through free-space propagation to the eye.

FIG. 1B provides an example of a light path for a transmissive hologram (e.g., light paths 1015, 1025), and illustrates that the HOE may be on a side of the lens 1030 nearest to an eye. FIG. 1C provides an example of a light path for a reflective hologram (e.g., light path, 1035), and illustrates the HOE 1020 may be placed on a side of a lens furthest from an eye. FIG. 1B shows two possible light paths. A first light path is shown indicating light propagating from an illumination system 1010 through the waveguide 1030 (e.g., a waveguide combiner) and an HOE 1020 to the hologram. The second light path is shown indicating light reflecting within the waveguide 1030 before propagating through the HOE 1020 to the hologram. FIG. 1C illustrates a reflective light path, in which light transmits through the waveguide 1030 to the HOE 1020 and reflects light through the waveguide 1030 to an eye. In various examples, the waveguide 1030 (e.g., a waveguide combiner) may, but need not, be curved. Any combination of the above techniques may be utilized in accordance with heterogeneous eye tracking, correlation, and gaze motion pattern determinations discussed herein. Various combinations may be useful to achieve certain goals or thresholds related to one or more of latency, bandwidth, power consumption, accuracy, or resolution, among others.

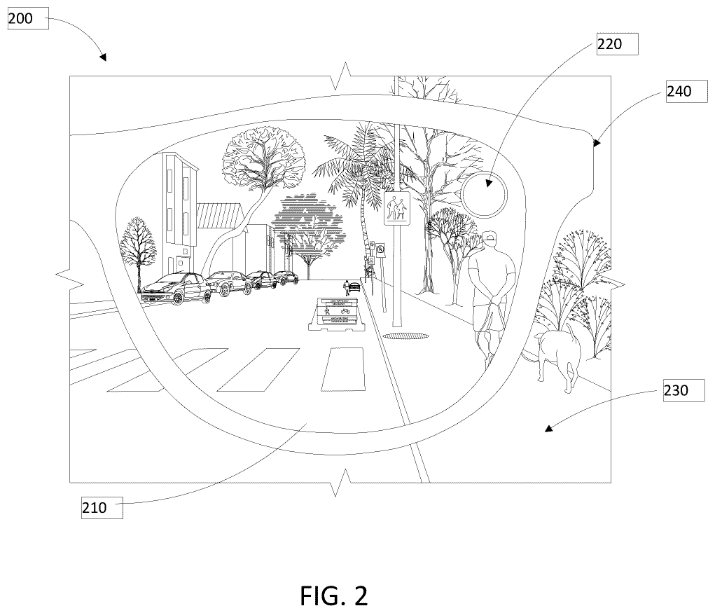

FIG. 2 illustrates an example of a display with a projected observable virtual image, in accordance with aspects discussed herein. A head-mounted system 200 may include a glasses frame and a display 210 enabling a view of a real-life or live scene 230. An observable virtual image 220 (also referred to herein as virtual image 220) may be provided on the display 210 of the head-mounted system 200. For example, the display 210 may correspond to a lens region of the glasses frame, and the observable virtual image 220 may be placed within the display area (see, e.g., display 210). In an example, the virtual image 220 may be an icon, such as for example a colored icon, a number, text, or other graphic. In other examples, the virtual image may be a static virtual image, and may comprise one or more icons. Icons may be driven by one or more sources, or even multiple segments of a segmented display. According to various aspects, the virtual image 220 may be placed in a static position. For example, the time may always be placed in the display region position shown in FIG. 2. The display region is associated with the display (e.g., display 210). In other examples, the virtual image may be dynamic, toggled on/off, and/or moved to various positions, for example, according to user preferences or settings.

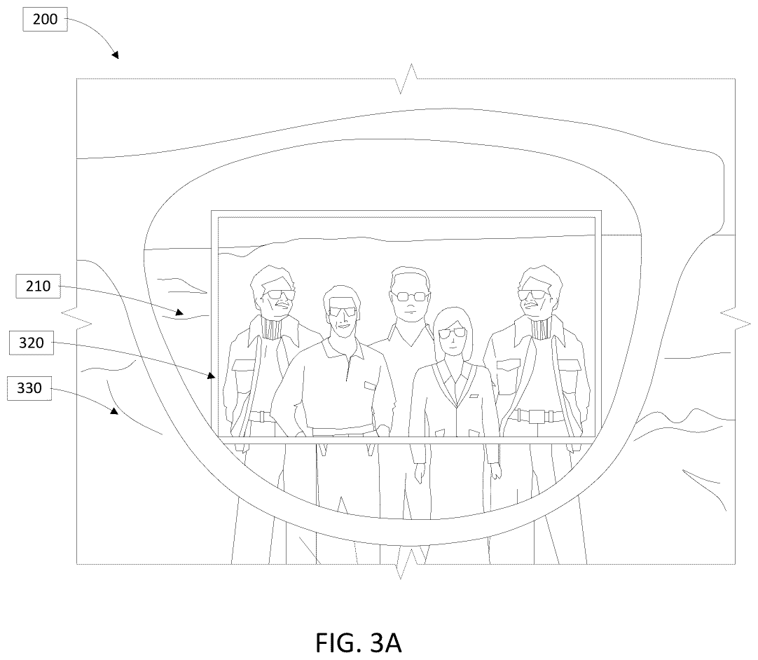

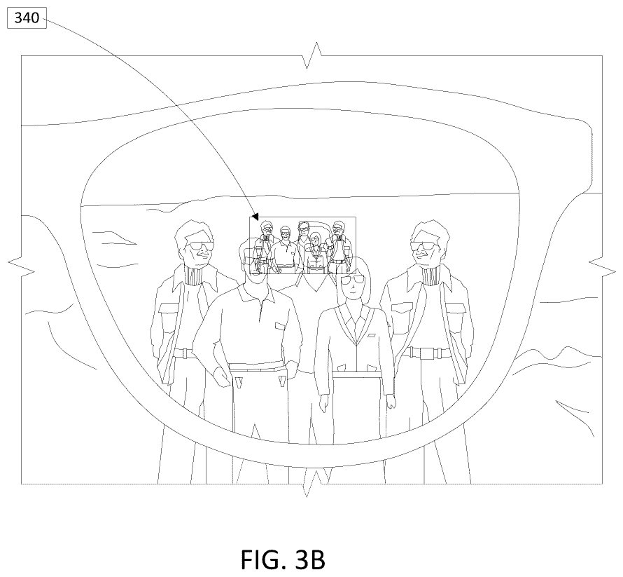

FIG. 3A illustrates an example, wherein an observable virtual image 320 may be utilized to aid in taking an action, such as capturing a photograph and/or a video. In a similar head-mounted system 200, the observable virtual image 320 may be a bounding box or a frame around a region of interest. The region of interest is outlined on a display (e.g., display 210) by the virtual image 320. The region of interest may be a region of viewable area 320 of a scene 330. In various examples, an action, such as taking a photo and/or a video may be captured, corresponding to the area within the virtual image 320. This may enable individuals wearing and using the head-mounted system 200 to take photographs and/or videos, without many of the viewfinder challenges discussed herein, and illustrated in FIG. 3B. This may allow the user of the head-mounted system to capture an image while directly enjoying the scene. In other words, a photograph and/or video may be captured as the user is directly looking at the scene, rather than traditional photography and videography, wherein a user looks at the scene through a scree in order to capture the desired view.

In some aspects, similar to other examples discussed herein, the virtual image 320 may be a static image corresponding to a region of the scene that the user is looking at, as determined by the eye tracking system (e.g., camera(s) 110a, 110b).

According to various aspects, the observable virtual image 320 may be a selectable virtual image. The selectable aspects may enable one or more actions and/or interactions to be performed. Selections may occur, for example, using a physical and/or virtual button or selection on the head-mounted system 200, such as a button placed on the glasses frame 240. In another example, the physical and/or virtual button may be on a connected device, such as for example a mobile computing device, remote control, or other computing device or peripheral as discussed herein. In some examples, selection and/or interaction may occur based on tracked eye movements. Focusing on an area, region, and/or virtual image for a period of time (e.g., 10 milliseconds, 1 second, 2 seconds, etc.) may cause an action to be taken, such as capturing a photo, initiating a video recording, and/or other action(s). Likewise, tracked eye movements indicating that the user is looking elsewhere and/or is not interested in the virtual image or virtual image region may cause the virtual image (e.g., observable virtual image 320) to move or turn off (e.g., by the head-mounted system 200).

FIG. 3B illustrates a viewfinder display, wherein the region to be captured by a camera is displayed in a miniaturized replication 340 on a display (e.g., a waveguide display with limited field of view). Such implementations may have many of the challenges discussed above, with respect to power consumption, user experience, user comfort, and ease of viewing. Since the display provides an additive picture over the generated scene, the viewer may need to switch their gaze and focus between the competing images (e.g., the additive picture and the generated scene). This may create an uncomfortable user experience and eye straining.

FIG. 4 illustrates various observable virtual images that may be generated and/or utilized in accordance with various aspects discussed herein. Numbers, texts, icons, images, and any of a plurality of visualizations may be provided by the HOE systems and methods discussed herein. For example, numbers and letters may be generated using a seven-segment display 420 or a fourteen-segment display 430. As discussed herein, virtual images may provide a time 410, an icon 415, such as a power level or other indication of system information. The virtual images may be positioned anywhere within the display region defined by display 210, turned on or off, moved, selected, and/or interacted with, as discussed herein. For example, the virtual images may be moved from a central area of the display 210 to a corner of the display. In some examples, the virtual images may be moved outside of a line of sight of the user, so that the user can more clearly and directly see the scene. In other examples the virtual images are turned off so as to not impede a user's view of the scene. The position changes may occur, for example, due to a user gaze or other inference based on a user's gaze (e.g., a user looks in a different area for a period of time).

In addition, it should be appreciated that HOEs may maintain high efficiency and transparency in an instance in which a low number of layers and/or exposures are used. Dynamic functionality may be made with finite symbols (e.g., like the fixed symbols on a car dash, like the engine light, the battery light, etc.). This may be very power efficient and provide significant power advantages compared to traditional displays. Increased functionality may be realized utilizing certain displays, e.g., the 7-segment displays 420 or 14-segment displays 430, or similar displays, for numbers and/or text.

In addition, separate HOEs may be utilized for various aspects of one or more virtual images. For instance, a clock may be made with one HOE for the “1” (double digit hour), one HOE for the “:”, and three 7-segment displays for a total of 23 HOE exposures. It should be appreciated that any of a combination of HOE types, symbols, icons, numbers, letters, colors, images, and/or the like may be utilized and implemented in accordance with various aspects provided herein.

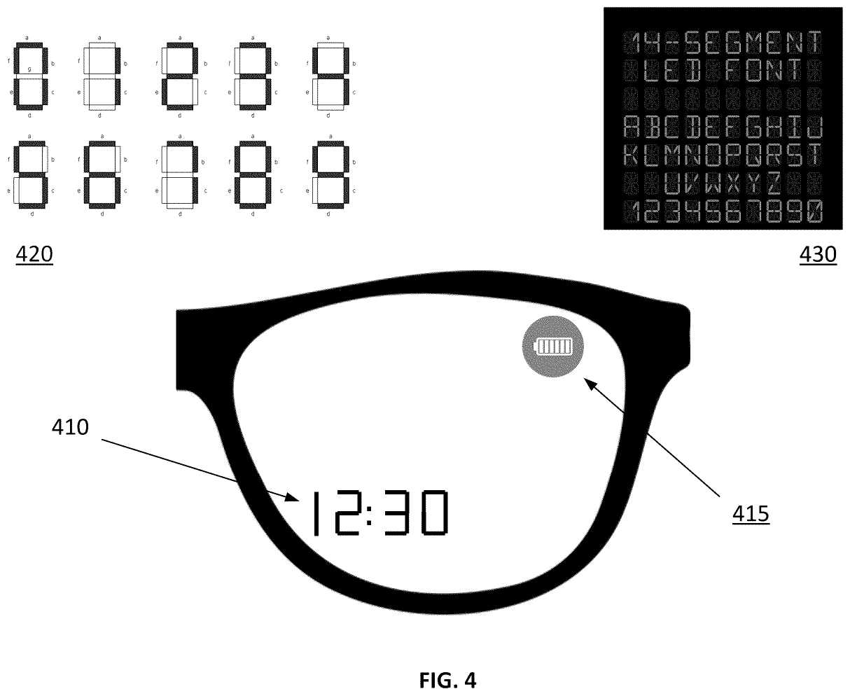

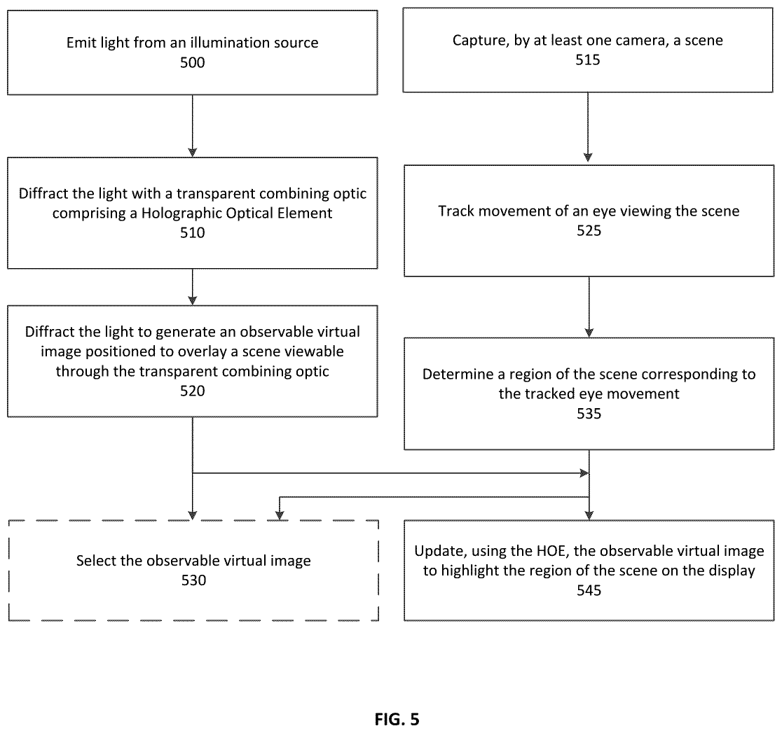

FIG. 5 illustrates a flow chart for providing observable virtual images. At block 500, a device (e.g., head-mounted system 200) may emit light from an illumination source. As discussed herein, an illumination source may include one or more illumination sources, and any combination of types of illumination sources. For example, one or more LEDs, LCD displays, lasers, and/or the like.

At block 510, a device may diffract the light with a transparent combining optic comprising a holographic optical element (e.g., HOE 170a, 170b).

At block 520, a device (e.g., head-mounted system 200) may diffract the light with a HOE (e.g., HOE 170a, 170b) to generate/produce an observable virtual image (e.g., virtual image 220). The observable virtual image may be positioned to overlay a scene viewable through the transparent combining optic. As discussed herein, the transparent combining optic may comprise the HOE. The HOE may diffract the light in any of a plurality of ways to produce/generate a desired observable virtual image (e.g., virtual image 220). One or more HOEs (e.g., HOE 170a, 170b) may be applied to produce/generate one or more virtual images (e.g., virtual image 220). For example, a plurality of HOEs may work together to produce a desired virtual image. At least one illumination source (e.g., illumination source 160a, 160b) may illuminate an HOE. HOEs may include one or more multiplexed HOEs. Likewise, a plurality of illumination sources (e.g., illumination source 160a, 160b) may illuminate an HOE. Illumination sources (e.g., illumination source 160a, 160b) may provide separate, unique light. Illumination sources may also be variable illumination sources. The light from separate illumination sources may correspond with each other to produce/generate one or more observable virtual images, using one or more HOEs. According to other aspects, a first illumination source (e.g., illumination source 160a, or illumination source 160b) in the plurality of illumination sources and a second illumination source (e.g., illumination source 160a, or 160b) in the plurality of illumination sources may separately emit light to illuminate the HOE. The light from the first illumination source and the light from the second illumination source may project different images when diffracted by the HOE.

As discussed herein, the observable virtual image may be produced on a display (e.g., display 210), and may be provided on a head-mounted system, such as for example smart glasses, an AR system, a lens, and any of a variety of displays (e.g., system 100, head-mounted system 200, etc.). The display may be a transparent display, such as lenses on a glasses system. The observable virtual image (e.g., virtual image 220) may be one or more of a letter(s), a number(s), an icon(s), and/or the like. The image may be selectable, as discussed herein. Some aspects may provide a plurality of observable virtual images. The observable virtual image may be positioned to overlay a scene viewable through the transparent combining optic.

Operations of blocks 515-545 may occur separately, independently, and/or concurrently with the operations at blocks 510-530. Such operations may relate to capturing a region of an observable scene, using various systems and methods discussed herein.

At block 515, a device (e.g., head-mounted system 200) may capture a scene by at least one camera (e.g., sensor system 110a, 110b, 150a, 150b). The camera may be an outward-facing camera (e.g., sensor system 150a, 150b), capturing a scene viewable by a user, such as a camera mounted on a glasses frame (e.g., sensor system 110a, 110b, 150a, 150b).

At block 525, a device (e.g., head-mounted system 200) may track movement of an eye viewing the scene (e.g., using sensor system 110a, 110b, 150a, 150b). For example, a user wearing smart glasses may be viewing a scene also captured by the at least one camera.

At block 535, a device (e.g., head-mounted system 200) may determine a region of the scene corresponding to the tracked eye movement. The tracked eye movement may indicate where the user (e.g., one or more of the user's eyes) is focusing within the scene, and one or more regions of interest associated with the scene. In an example, at least one system (e.g., head-mounted system 200) may track movement of an eye viewing the scene, determine a region of the scene corresponding to the tracked eye movement, and update the observable virtual image to highlight the region of the scene. For example, the tracked eye movement, by the sensor system, may correspond to field of views 140a, 140b.

At block 545, a device (e.g., head-mounted system 200) may update, using the HOE, the observable virtual image to highlight the region of the scene on the display (see, e.g., FIG. 2, 3A, 3B). Highlighting the region may include providing a bounding box (e.g., viewable area 320) around the region of the scene of interest or providing another image corresponding to the region of the scene of interest (e.g., miniaturized replication 340) within the scene (e.g., scene 330).

Optionally, at block 530, a device (e.g., head-mounted system 200) may select the observable virtual image (e.g., observable virtual image 320, miniaturized replication 340). The selection may occur, for example, based on a length of a user's gaze on the area (e.g., a predetermined period of time, such as 1, 2, 3, seconds, etc.) Other actions, such as a selection of a button on a glasses frame, may select the observable virtual image.) Such operations may be optional, as not all observable virtual images may be selectable, and not all selectable observable virtual images may need to be selected. According to various aspects, selection of an observable virtual image (e.g., observable virtual image 320) may cause an action to be taken, such as capturing a photograph/image and/or taking a video of an area within the observable virtual image. Other actions may be associated with selecting the observable virtual image to provide additional information, such as time, battery information, system information, and/or any of a plurality of icons, applications (apps), and/or indications which may be provided by the observable virtual image.

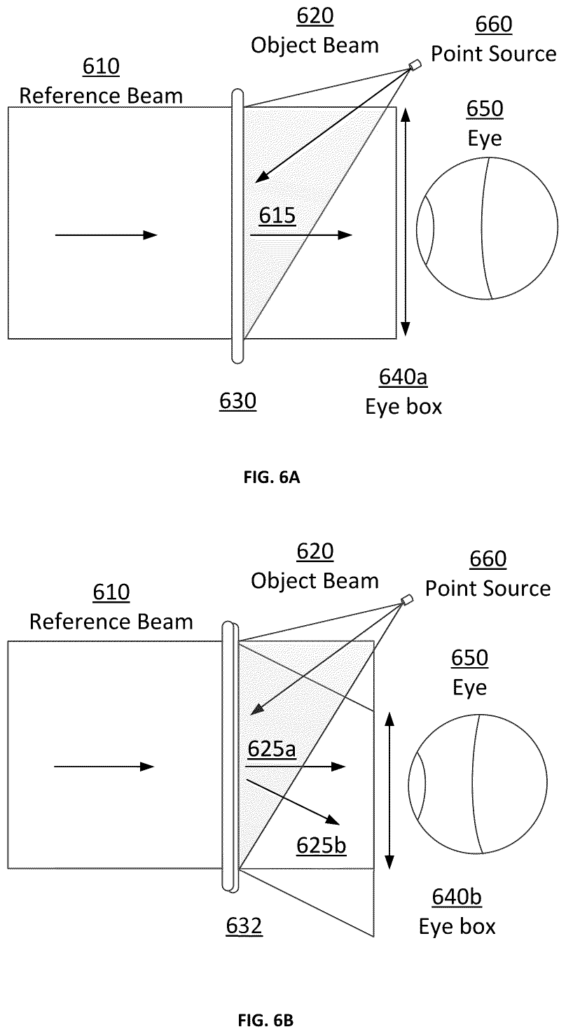

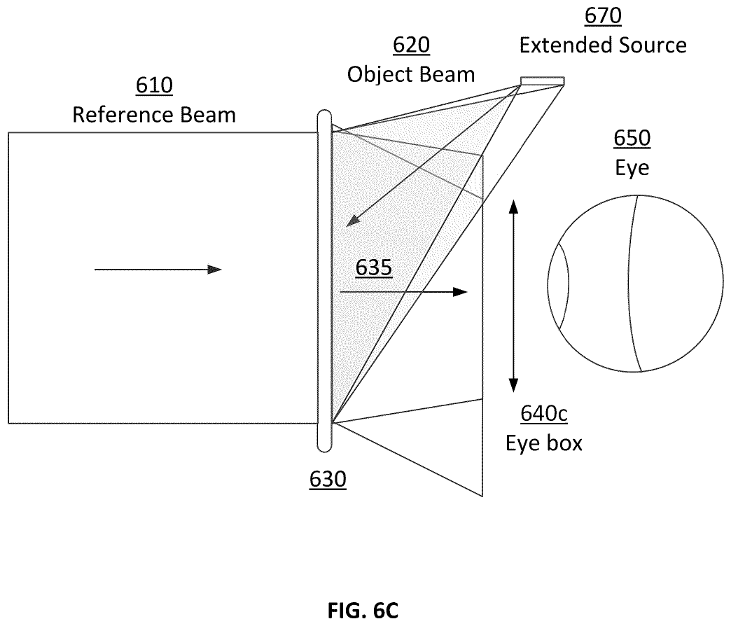

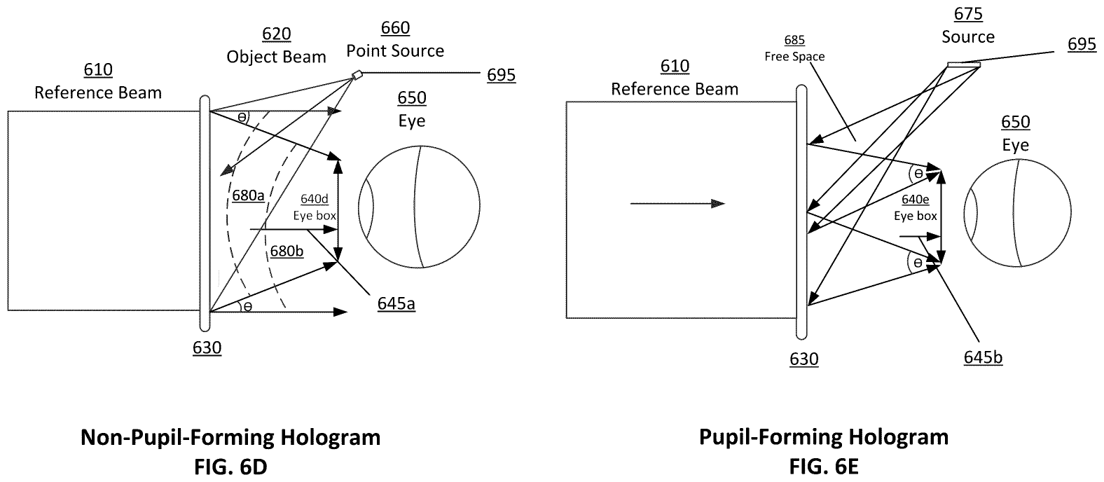

FIGS. 6A, 6B, and 6C illustrate example hologram systems for generating an eye box and a virtual image observable within the eye box. FIG. 6D illustrates an example hologram system for generating a non-pupil-forming hologram. FIG. 6E illustrates an example hologram system for generating a pupil-forming hologram. Such hologram systems may be usable with head-mounted devices, as described herein. Hologram systems may include an illumination source, such as point source 660 or extended source 670 (e.g., a projector) to generate an object beam towards a first side of a transparent optical element 630, also referred to herein as a transparent combining optic, which may include a film and holographic optical element. In some examples the transparent optical element may be a photosensitive film. As discussed herein, the illumination source (e.g., point source 660, extended source 670, source 675) may be secured to a head-mounted device, such as a frame or arm of glasses, another portion of the head-mounted device, or to another wearable device. The illumination source may also be located at any distance (e.g., near, far, etc.) from the transparent optical element, and positioned to enable formation of a collimated beam.

A reference beam 610 may be received at a second side of the transparent optical element. The reference beam may be natural light transmitting through the lens (e.g., the environment, a natural scene, etc.). In other examples, the reference beam may originate from a light source and have one or more defined light parameters (e.g., wavelength, brightness, intensity, etc.). The first side of the transparent optical element may be the side adjacent to an eye 650 and may be the side from which a user views a scene and looks through the transparent optical element. The first side and the second side may be opposite, depending on the optical element. The transparent optical element combines the reference beam 610 and the object beam 620 to generate an eye box 640a, 640b, 640c and an observable virtual image(s) 615, 625a, 625b, 635 within the eye box. The eye box 640a may be the entire projected field of view area that the eye 650 may view. As discussed above, the observable virtual image(s) may be configured to overlay a scene viewable through the transparent optical element. Such hologram systems may be applicable to augmented reality (AR), virtual reality (VR), and/or other hybrid reality systems.

In various examples, aspects corresponding to a Volume Bragg Grating (VBG) hologram may be implemented. In various examples, a coherent laser beam may be split into two beams. The two beams, commonly called the “reference beam” and the “object beam,” may overlap onto a photosensitive (e.g., light sensitive) holographic film. The overlapping two beams may interfere, causing a standing wave grating of spatially varying amplitude (e.g., regardless of whether the photosensitive holographic film is present). The photosensitive holographic film may record the spatial variation by a refractive index change. Areas with higher amplitude light within the grating volume may have more refractive index change, and areas with less amplitude light within the grating volume may have less refractive index change. After recording, in an instance in which the hologram is illuminated with one of the two beams, or a light source of similar nature, the light may be diffracted into the path of the other beam and may be reconstructed.

FIG. 6A illustrates an example in which a point source 660 may be directed towards the transparent optical element 630, including a film/HOE, and may be combined with the reference beam 610 to generate an eye box 640a. The arrows may represent the beam propagation direction.

In such examples, in an instance in which an equivalent point source is positioned at the location of point source 660, the illumination may be diffracted to follow the path of reference beam 610 and may appear to propagate from the reference beam point source location, e.g., originating from the opposite, or second, side of the transparent optical element.

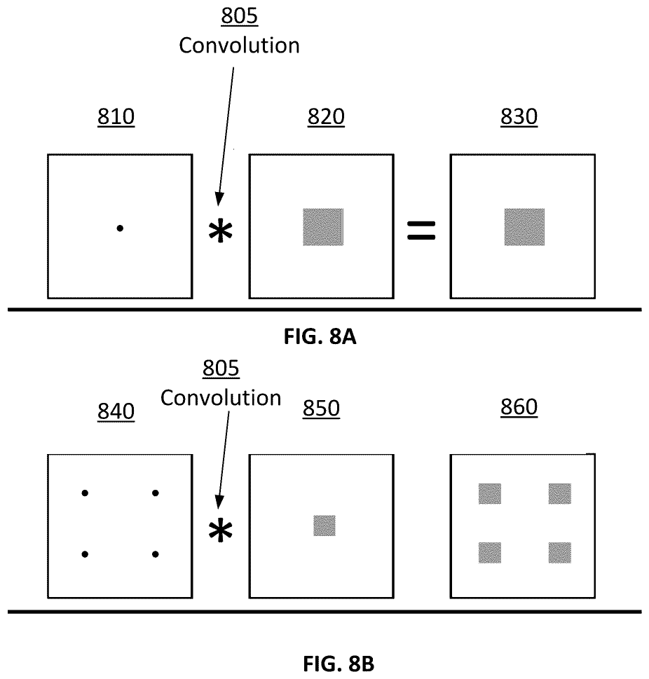

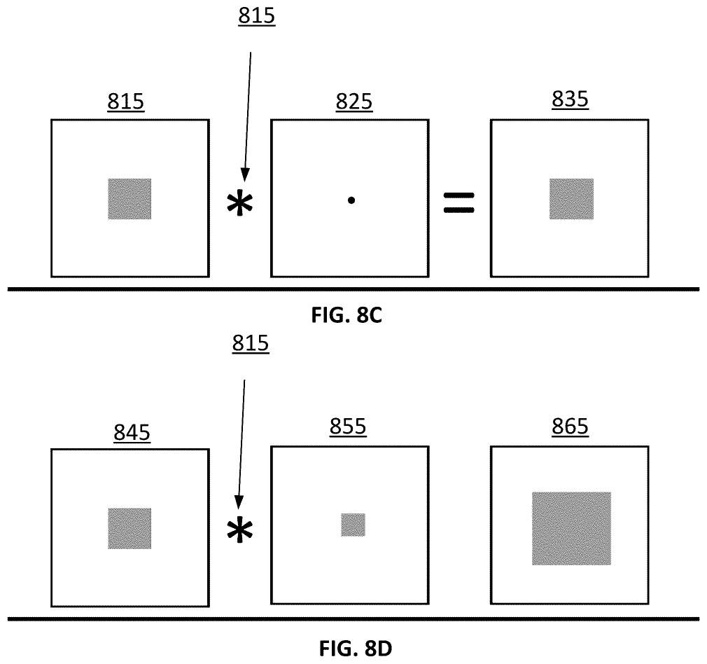

The size of eye box 640a may depend on the sizes of reference beam 610, object beam 620, and the transparent optical element 630 (e.g., film/HOE), and therefore the eye box 640a may be sized as desired. The etendue (E) of a hologram output may be expressed by the eye box size (A) multiplied by the field of view of the projected image (Ω) to form an A-Omega Product (E=A*Ω). The transparent optical element 630, e.g., a film/HOE, may therefore, diffract light paths from both beams (e.g., reference beam 610, object beam 620), and may reconstruct a viewable observable image (see, e.g., viewable observable image 830, 835, 860, 865 of FIGS. 8A, 8B, 8C, and 8D) within an eye box.

FIG. 6B illustrates an example in which the transparent optical element 632 may have multiple layers of at least on one of a film and a HOE, which may result in multiple holograms. Layers within the transparent optical element may receive light from one or more illumination sources and may interact with different light parameters. Such light parameters may include wavelength and/or polarization. Such layers may, for example, generate different observable virtual images, multiplex one or more object beams 620, and may create complex holograms (e.g., observable virtual images 625a, 625b, viewable by the eye 650. The eye box 640b may also be modified via the multilayered transparent optical element 632. In FIG. 6B, eye box 640b may have changed based on the multilayered transparent optical element 632. In particular, the eye box size may have been reduced because of the reduced overlapping area at the distance of the user's eye (e.g., eye 650). In some examples, this may be remedied by offsetting exposure areas of each layer/exposure of the transparent optical element 632 to overlap the diffracted beams at the eye relief, which may be the distance from the transparent optical element 632 (e.g., film/HOE) to the eye (e.g., eye 650).

In some examples, holograms may be multiplexed with multiple exposures, using multiple illumination sources and/or combinations of illumination sources (e.g., point source(s), extended source(s), etc.). Each exposure in the transparent optical element may interact with different illumination sources and may have different resulting combinations with respect to light parameters. Different beams, from one or more illumination sources, may be simultaneously diffracted from different layers and/or multiplexed exposures. As a result, the eye 650 may see multiple illumination sources simultaneously within the eye box (e.g., eye box 640b).

FIG. 6C illustrates an example in which the illumination source includes at least one extended source 670. The object beam 620 from the extended source may diffract and may combine with the reference beam 610 to form an observable virtual image 635 within an extended field of view (e.g., eye box 640c). The extended source 670 may create variations on the observable virtual image (e.g., observable virtual image 635), as discussed in FIGS. 8A, 8B, 8C, and 8D.

In an example, in an instance in which an extended source (e.g., extended source 670) illuminates the transparent combining optic 630, the illuminated hologram (e.g., observable virtual image 635) and the field of view may be convolved by the angular extent of the extended source within the supported angular and/or spectral bandwidth. In other words, compared to a point source in the same position, the extended source may be extended based on the degree of convolution. Accordingly, the field of view observed by a user (e.g., via eye 650) may be larger than that of a point source, and thereby may form an extended eye box.

FIG. 6D illustrates an example of a non-pupil-forming hologram system, and FIG. 6E illustrates an example of a pupil-forming hologram system. A pupil-forming hologram system may modulate light (e.g., phase and/or amplitude, etc.) passing through the system, for instance by diffraction (by transparent optical element 630 (e.g., film/HOE)), to direct light toward a pupil plane that may be used as an eyebox by a pupil of an eye (e.g., eye 650) to view a virtual image. A non-pupil-forming hologram may modulate light (e.g., phase and/or amplitude, etc.), for instance by diffraction (by transparent optical element 630 (e.g., film/HOE)), to generate a virtual image, not all the light directed toward a pupil plane, but rather the light directed toward an extended area of a plane, a subset of which may be used as an eyebox by a pupil of an eye (e.g., eye 650) to view a virtual image. In examples, an eyebox may refer to a region, such as a two-dimensional or three-dimensional area in which a viewing object, such as an eye, may receive an entire image. In some examples, the eyebox may refer to the region in which an eye may clearly see an image, for example, without any edge shading or distortion. In examples, a non-pupil-forming hologram may record the hologram at a distance from an object, and reconstruct an interference pattern (e.g., between a reference beam and an object beam) on a photosensitive medium. In examples, illumination of the hologram may reconstruct a three-dimensional image.

As discussed herein, a transparent combining optic may include a holographic optical, which may be encoded using one or more holographic recording techniques (see, e.g., FIGS. 6A-6C). In FIG. 6D, in the non-pupil-forming hologram system, a point source 660, which may be any of a plurality of illumination sources discussed herein, illuminates a transparent optical element 630. An observable image 645a may be generated with a non-pupil-forming eyebox 640d. Elements 680a, 680b may be parallel, or otherwise diverging from the same distance virtual point, to signify rays of an equivalent field point of a field of view of a virtual image, and the combined elements 680a, 680b illustrate a range of the field of view formed in the non-pupil-forming hologram system. The angle,Θ, illustrates the field of view observable with the eyebox 640d, which the eye 650 may see. In other words, the observable image 645a may be positioned and viewable within eyebox 640d, and the eyebox may cover a portion of the total area of the footprint of the rays of light at some distance from the transparent combining optic.

FIG. 6E illustrates an example of a pupil-forming hologram system, in which an illumination source 675, such as a projector, illuminates a transparent optical element 630 and generates a pupil plane, equivalently eyebox 640e, from which an eye (e.g., eye 650) may view the field of view (e.g.,Θ). The illumination source 675 may include one or more of a point source, an extended source, or an array of one or more illumination sources.

According to various examples, the transparent combining optic 630 may include a holographic optical element including at least one of a point-source, hologram, an etendue expansion hologram, a set of multiplexed holograms, a layered stack of multiple holograms, or a patterned array of multiple holograms. the virtual image 645b may include content defined by a distribution of the illumination source. In other examples, the virtual image 645b may include content defined by an encoding of the holographic optical element. The transparent combining optic may include a photosensitive holographic film.

As seen in FIG. 6E, light may propagate through free space 685 and diffract via the transparent combining optic 630. In some examples, the light may include non-replicating light paths. FIG. 6E shows light propagating via unique paths without being split duplicated. In some examples, the transparent combining optic 630, including a holographic optical element may be positioned relative to the source 675 such that the source 675 is at a point of illumination, and light propagates through the point of illumination. The point of illumination may be an image point or a focal point where light beams converge and/or intersect. Thus, the illumination source 675 may be positioned at the point of illumination of the transparent combining optic 630.

In some examples, holograms may be Volume Bragg Grating holograms fabricated using one or more point sources. Such examples may support a larger angular bandwidth and/or a larger spectral bandwidth. Such bandwidths may be dependent on one or more parameters of the transparent optical element 630, such as refractive index variation and film thickness. Optical aberrations may be another effect to consider when choosing which illumination sources to use. Extended sources may degrade in sharpness, brightness, and overall performance as the distance increases between the extended source (e.g., extended source 670) and the transparent optical element 630. Additionally, as discussed herein the illumination source (e.g., point source 660, extended source 670, source 675) may be secured to a head-mounted device, such as a frame of a head-mounted device. The illumination source may also be positioned outside of a field of view of a user wearing the head-mounted device.

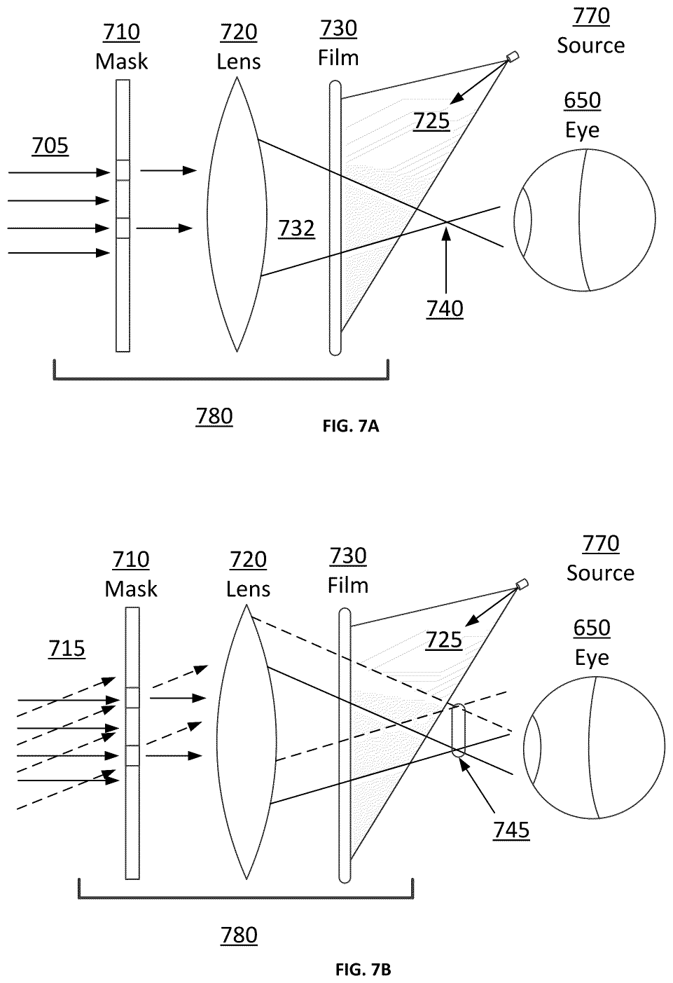

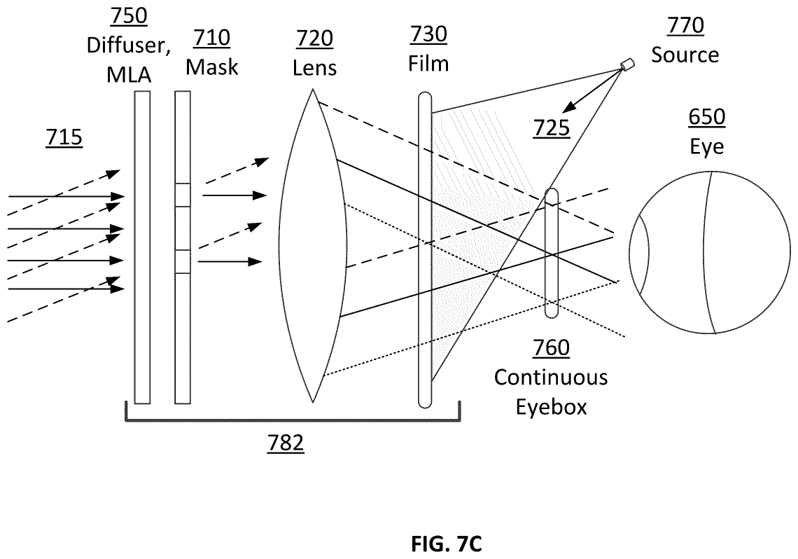

FIGS. 7A, 7B, and 7C illustrate examples of a multiplexed holographic exposure system. In such examples, the transparent optical element (e.g., transparent optical elements 780) may include a mask 710, a lens 720, and a film 730. A transparent optical element (e.g., transparent optical element 782) may also include a diffuser and/or a microlens array (MLA) 750 may also be included, as shown in FIG. 7C. An illumination source 770 may be a point source, an extended source, and/or any combination of one or more sources and may project an object beam to a first side of the transparent optical element (e.g., transparent optical elements 780, 782). Reference beam(s) 705, 715, may be received at a second side from one or more angles. FIGS. 7A, 7B, and 7C illustrate optical paths of the reference beams 705, 715, and object beam 725.

In FIG. 7A, the collimated beams 705, 725 may be masked through a hologram 732 to form an extended field of view and may generate a tiny eye box, effectively a point 740, with a very small etendue when reconstructed. In FIG. 7B, multiple hologram layers and/or multiple exposures vary angles of collimated beams are shown, thus enabling a larger resulting eye box 745. Eye box 745 may have a larger size compared to a point source (e.g., illumination source 770 of FIG. 7A) and may experience tradeoffs with respect to efficiency, brightness, and performance. FIG. 7C illustrates another example including an additional optical element, which may be a diffuser and/or a microlens array 750. In such examples, when illuminated by an illumination source (e.g., illumination source 770), the transparent optical element 782 may display an extended field of view (see, e.g., continuous eye box 760), greatly defined by the mask 710, lens 720, and film 730.

FIGS. 8A, 8B, 8C, and 8D illustrate various example hologram projections within an eye box, resulting from various hologram systems and configurations discussed herein. FIG. 8A illustrates a point source hologram field of view 810 being convolved with an extended source 820 via a convolution operation 805 to generate observable virtual image 830. FIG. 8B illustrates element 840 representing a multiplexed point source hologram convolved with an extended source 850 via a convolution operation 805 to generate a second observable virtual image 860. The second observable virtual image 860 shows expansions of the multiplexed point source holograms. In such examples, the multiple point source holograms (e.g., observable virtual image 860) may be one or more infinitely small points. FIGS. 8A-8B show a manner in which multiple layers or multiple exposure multiplexing are utilized such that the angular extent of the extended source may be convolved by the reference point source of each hologram. As such, a larger field of view may be projected, and even include multiple points.

FIGS. 8C-8D illustrate an example of etendue expansion, as discussed herein. The etendue expanded holograms 835, 865, may be generated using a diffuser and/or microlens array (e.g., diffuser and/or microlens array 750) as discussed above. A convolution 815 may convolve a recorded field of view (e.g., etendue expanded holograms 830, 835, 860, 865) by an illumination source used for reconstruction (e.g., point source illumination 825, extended source illumination 855) to generate respective observable virtual images 835, 865. In various examples, in an instance in which an ideal point source illumination is utilized, the reconstruction of the field of view may be ideal. If an extended source is utilized, the reconstruction may be convolved by a blur of the angular extent of the extended source. The result may therefore be blurred from the original reference image, and may result in other visual features such as a diminishing edge brightness or blurring.

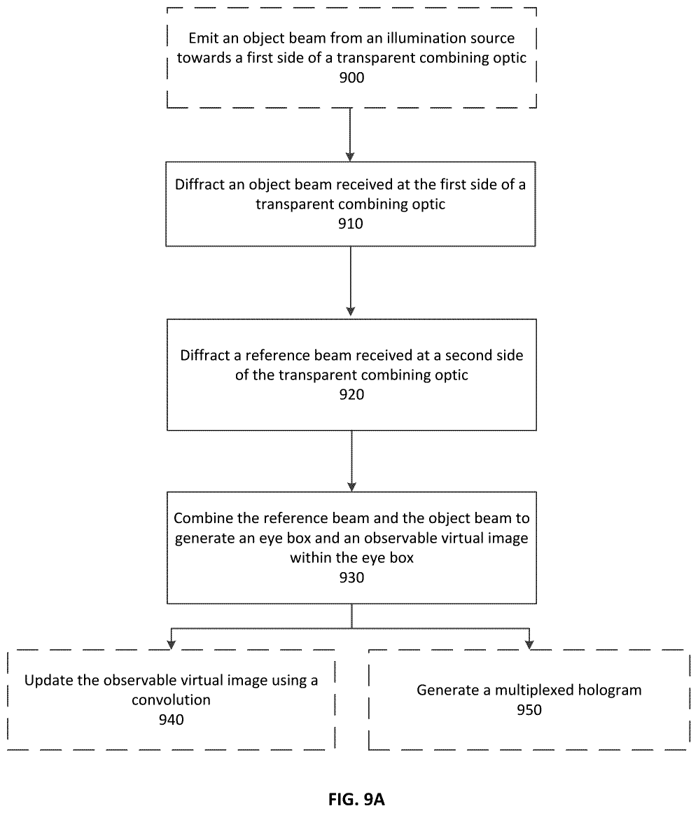

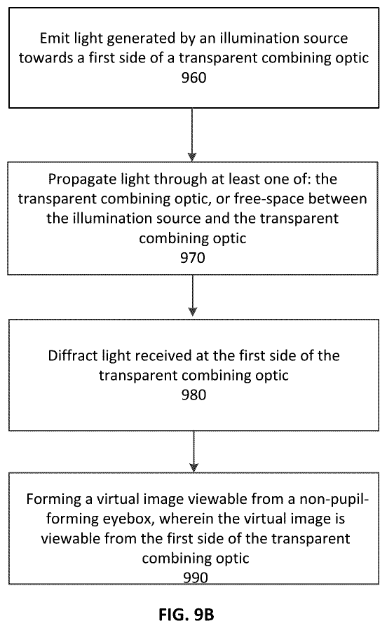

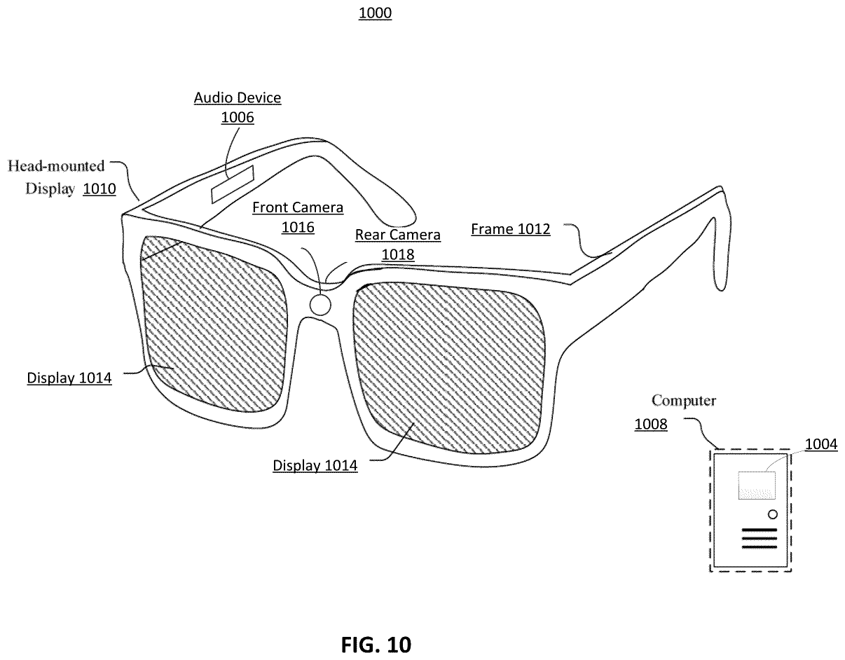

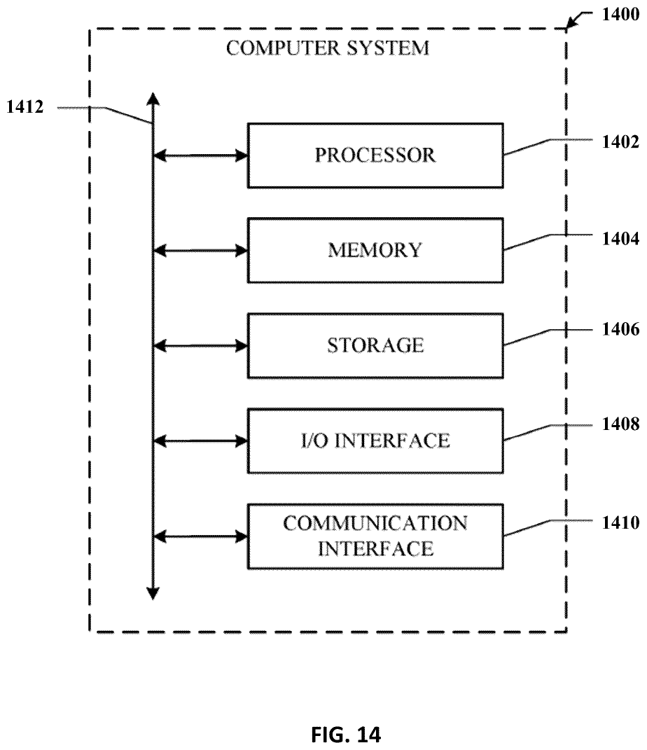

FIG. 9A illustrates an example flow chart for generating an eye box, an observable virtual image, and/or a multiplexed hologram, in accordance with various aspects discussed herein. Blocks 900, 940, and 950 are outlined in dashed lines, as they refer to operations which may occur via one or more computing devices. The computing device may include the computer system 1400 of FIG. 14, head-mounted system 200 of FIG. 2, head-mounted display 1010 of FIG. 10 as well as one or more processors, memories, and non-transitory computer-readable mediums executing instructions to perform such operations. Blocks 910, 920, 930 indicate operations which may occur via the transparent combining optic (e.g., transparent optical element 630, 634, 780, 782) and holographic optical element systems (e.g., FIGS. 6A-6C and 7A-7C), as discussed herein.

At block 900, a device (e.g., head-mounted system 200, head-mounted display 1010, computer system 1400) may emit an object beam from an illumination source (e.g., source 660, 670, 675) towards a first side of a transparent combining optic. As discussed herein, an illumination source may include one or more illumination sources (e.g., source 660, 670, 675), and any combination of types of illumination sources. For example, one or more LEDs, LCD displays, lasers, point sources, extended sources, and/or the like.

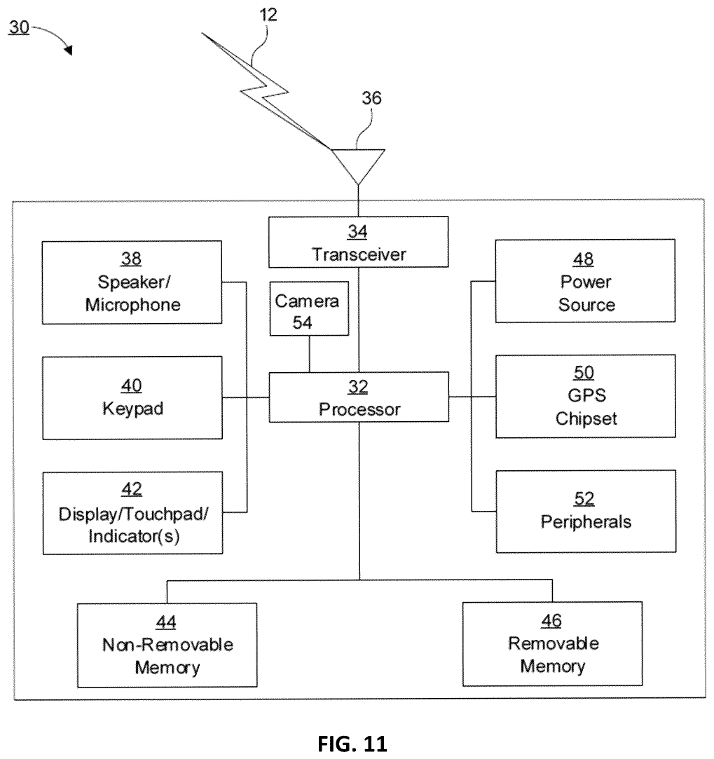

At block 910, example aspects may diffract the object beam received at the first side of the transparent combining optic (e.g., transparent optical element 630, 632, 780, 782), which may include at least one a film and a HOE, systems of FIGS. 6A, 6B, 6C and 7A, 7B, 7C). The first side of the transparent combining optic may be a side through which a user, eye, or other viewing device may look through the transparent combining optic. In some examples, as discussed herein, the transparent combining optic may form a part of a frame, lens or display (e.g., head-mounted device 200 of FIG. 2, head-mounted display 1010 of FIG. 11).

At block 920, example aspects may diffract a reference beam received at a second side of the transparent combining optic (e.g., transparent optical element 630, 632, 780, 782). The second side of the of the transparent combining optic (e.g., transparent optical element 630, 632, 780, 782) may be an opposite side of the first side of the transparent combining optic (e.g., transparent optical element 630, 632, 780, 782). For example, the second side may be an opposite side of the transparent combining optic, or a lens associated with the transparent combining optic (e.g., transparent optical element 630, 632, 780, 782). In other examples, the second side may be a side through which a reference beam is received, which may or may not be exactly opposite the first side. The reference beam (e.g., reference beam 610, 705, 715) may include light waves corresponding to a scene viewable through the transparent combining optic. In other examples, the reference beam may be a particular light beam directed through a lens (e.g., transparent optical element 630, 632, 780, 782), which may have certain light parameters interacting with the transparent combining optic. Such light parameters may include wavelength, polarization, frequency, and/or other characteristics which may be filtered, blocked, diffracted, and otherwise modified when passing through the transparent combining optic.

At block 930, example aspects may combine the reference beam and the object beam (e.g., object beam 620) to generate an eye box (e.g., eye boxes 640a, 640b, 640c, 645a, 645b, 740, 745, 760) and an observable virtual image (e.g., beam 615, 625a, 625b, 635, 830, 835, 860, 865) within the eye box.

At block 940, a device (e.g., head-mounted system 200, head-mounted display 1010, computer system 1400) may update the observable virtual image (e.g., observable virtual image 615, 625a, 625b, 635, 645a, 645b, 830, 835, 860, 865) using a convolution. In some examples, the convolution may be an etendue expansion convolution (e.g., convolution 805, convolution 815). The convolution may expand a hologram (e.g., 810, 815, 840, 845), which may be a point, an expanded point, or other shape, and may create an observable virtual image (e.g., observable virtual image 615, 625a, 625b, 635, 645a, 645b, 830, 835, 860, 865) in a particular location within an eye box (e.g., eye boxes 640a, 640b, 640c, 640d, 640e, 740, 745, 760).

At block 950, a device (e.g., head-mounted system 200, head-mounted display 1010, computer system 1400) may generate a multiplexed hologram. As discussed herein, the transparent combining optic (e.g., transparent optical element 630, 634, 780, 782) may include one or more layers and may create one or more observable virtual images (e.g., observable virtual image 615, 625a, 625b, 635, 645a, 645b, 830, 835, 860, 865) having various shapes, sizes, colors, brightness, and visual properties. The transparent combining optic may also multiplex various observable virtual images in various positions within an eye box (e.g., eye boxes 640a, 640b, 640c, eyebox 645a, eyebox 645b, eye box 740, eye box 745, eye box 760; see also FIGS. 8A, 8B, 8C, 8D) to create desired visual effects.

Operations of blocks 900-950 may occur separately, independently, and/or concurrently. Such operations may relate to capturing a region of an observable scene, using various systems and methods discussed herein.

FIG. 9B illustrates an example flow chart for forming a virtual image viewable from a non-pupil-forming eye box, in accordance with various aspects discussed herein. Blocks 960, and 970, as discussed herein, may occur via one or more computing devices. The computing device may include the computer system 1400 of FIG. 14, head-mounted system 200 of FIG. 2, head-mounted display 1010 of FIG. 10 as well as one or more processors, memories, and non-transitory computer-readable mediums executing instructions to perform such operations. Blocks 980 and 990 indicate operations which may occur via the transparent combining optic (e.g., transparent optical element 630, 634, 780, 782) and holographic optical element systems (e.g., FIGS. 6A-6E and 7A-7C), as discussed herein.

At block 960, a device (e.g., head-mounted system 200, head-mounted display 1010, computer system 1400) may emit light generated by an illumination source (e.g., source 660, 670, 675) towards a first side of a transparent combining optic. As discussed herein, an illumination source may include one or more illumination sources (e.g., source 660, 670, 675), and any combination of types of illumination sources. For example, one or more LEDs, LCD displays, lasers, point sources, extended sources, and/or the like.

At block 970, example aspects may propagate light through at least one of: transparent combining optic (e.g., transparent optical element 630, 632, 780, 782), or free-space (e.g., free space 685) between the illumination source and the transparent combining optic. As which may include at least one a film and a HOE, systems of FIGS. 6A, 6B, 6C, 6D, 6E, and 7A, 7B, 7C). The first side of the transparent combining optic may be a side through which a user, eye, or other viewing device may look through the transparent combining optic. In some examples, as discussed herein, the transparent combining optic may form a part of a frame, lens or display (e.g., head-mounted device 200 of FIG. 2, head-mounted display 1010 of FIG. 11).

At block 980, example aspects may diffract light received at the first side of the transparent combining optic (e.g., transparent optical element 630, 632, 780, 782). As discussed herein, the transparent combining optic may be configured affect various light parameters including but not limited to wavelength, polarization, frequency, and/or other characteristics which may be filtered, blocked, diffracted, and otherwise modified when passing through the transparent combining optic.

At block 990, example aspects may form a virtual image across a non-pupil-forming eyebox (e.g., eye boxes 640a, 640b, 640c, 640d, 640e, 740, 745, 760), wherein the virtual image (e.g., observable virtual image 615, 625a, 625b, 635, 645a, 645b, 830, 835, 860, 865) is viewable from the first side of the transparent combining optic.

Operations of blocks 960-990 may occur separately, independently, and/or concurrently. Such operations may relate to capturing a region of an observable scene, using various systems and methods discussed herein.

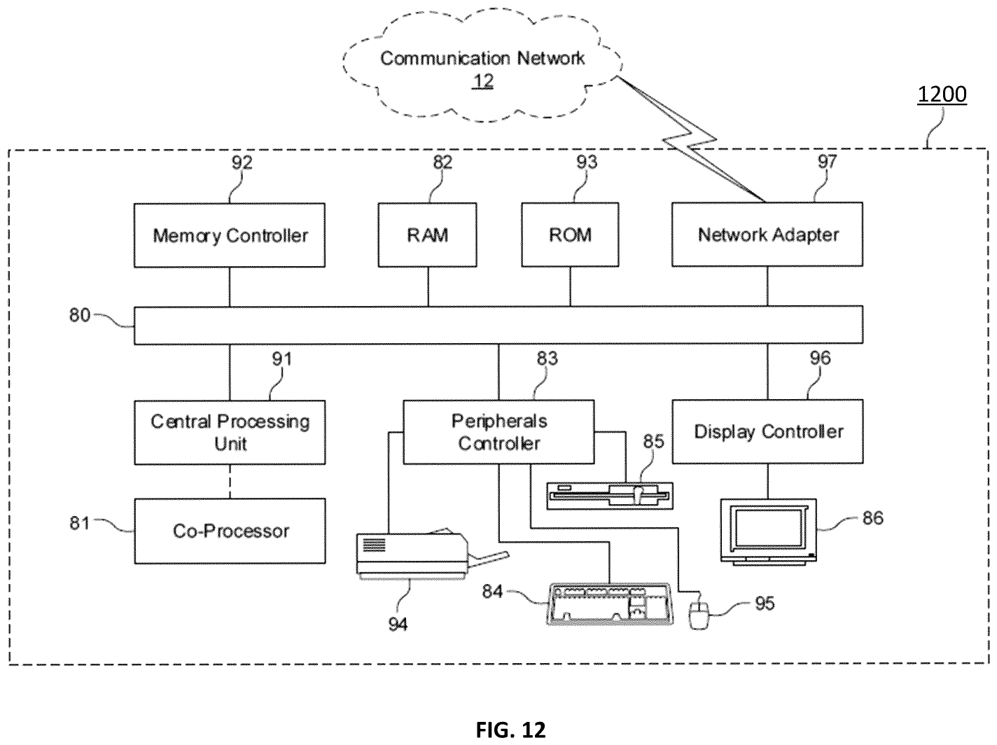

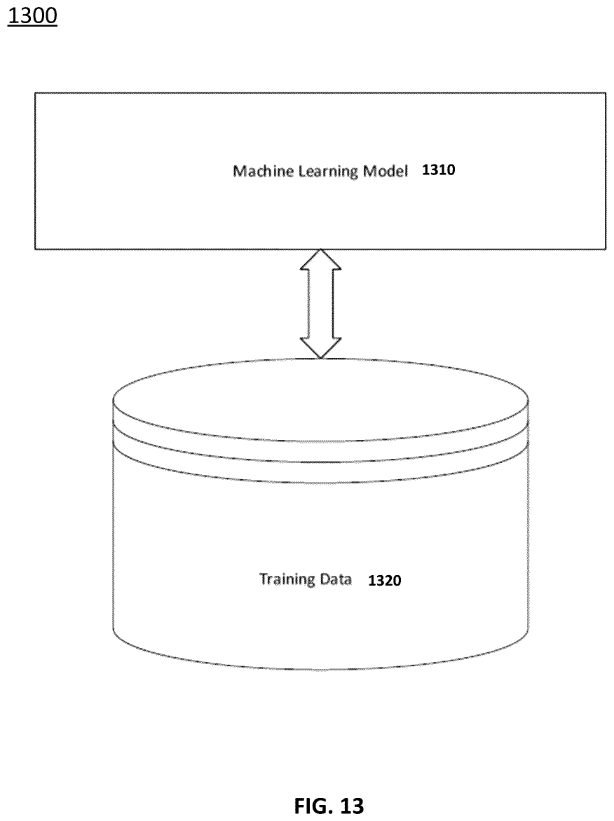

In some examples, the augmented reality system 600 of FIG. 10 may perform the operations/functions of blocks 500, 510, 520, 530, blocks 515, 525, 535, 545, and blocks 910, 920, 930, 940, and 950. In some other examples, the system 100 of FIG. 1A, the UE 30 of FIG. 11, the computing system 1200 of FIG. 12, the framework 1300 of FIG. 13 and/or the computer system 1000 of FIG. 14 may perform some, or all, of the operations/functions of blocks 500, 510, 520, 530, blocks 515, 525, 535, 545, and blocks 910, 920, 930, 940, and 950.

In one example, the illumination source may include a first illumination source and a second illumination source separately emitting light, the HOE may be a multiplexed HOE, and a plurality of observable virtual images may be generated. The observable virtual images may be propagated through free space. In a multiplexed, HOE, multiple channels (e.g., digital or analog signals) are combined into a composite signal, which may generate the observable virtual image. In another example, the illumination source may be a variable illumination source, the HOE may be a multiplexed HOE, and a plurality of observable virtual images may be generated, with at least one observable virtual image being selectable.

FIG. 10 illustrates an example augmented reality system 1000. In some examples, the augmented reality system 1000 may be an example of the head-mounted system 100. The augmented reality system 1000 may include a head-mounted display (HMD) 1010 (e.g., glasses) comprising a frame 1012, one or more displays 1014, and a computer 1008 (also referred to herein as computing device 1008). The displays 1014 may be transparent or translucent allowing a user wearing the HMD 1010 to look through the displays 1014 to see the real world and displaying visual augmented reality content to the user at the same time. The HMD 1010 may include an audio device 1006 (e.g., speaker/microphone 38 of FIG. 11) that may provide audio augmented reality content to users. The HMD 1010 may include one or more cameras 1016, 1018 which may capture images and/or videos of environments. The HMD 1010 may include an eye tracking system to track the vergence movement of the user wearing the HMD 1010. In one example embodiment, the HMD 1010 may include a camera(s) 1018 (also referred to herein as rear camera 1018) which may be a rear-facing camera tracking movement and/or gaze of a user's eyes.

One of the cameras 1016 (also referred to herein as front camera 1016) may be a forward-facing camera capturing images and/or videos of the environment that a user wearing the HMD 1010 may view. The HMD 1010 may include an eye tracking system to track the vergence movement of the user wearing the HMD 1010. In one example, the camera(s) 1018 may be the eye tracking system. The HMD 1010 may include a microphone of the audio device 1006 to capture voice input from the user. The augmented reality system 1000 may further include a controller 1004 (e.g., processor 32 of FIG. 11) comprising a trackpad and one or more buttons. The controller 1004 may receive inputs from users and relay the inputs to the computing device 1008. The controller 1004 may also provide haptic feedback to users. The computing device 1008 may be connected to the HMD 1010 and the controller 1004 through cables and/or wireless connections. The computing device 1008 may control the HMD 1010 and the controller 1004 to provide the augmented reality content to and receive inputs from one or more users. In some example embodiments, the controller 1004 may be a standalone controller or integrated within the HMD 1010. The computing device 1008 may be a standalone host computer device, an on-board computer device integrated with the HMD 1010, a mobile device, or any other hardware platform capable of providing augmented reality content to and receiving inputs from users. In some examples, HMD 1010 may include an augmented reality system/virtual reality system (e.g., artificial reality system).

FIG. 11 illustrates a block diagram of an example hardware/software architecture of a UE 30. As shown in FIG. 11, the UE 30 (also referred to herein as node 30) may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The UE 30 may also include a camera 54. In an example, the camera 54 may be a smart camera configured to sense images appearing within one or more bounding boxes. The UE 30 may also include communication circuitry, such as a transceiver 34 and a transmit/receive element 36. It should be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another embodiment, the transmit/receive element 36 may be configured to transmit and receive both RF and light signals. It should be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCad), nickel-zinc (NiZn), nickel metal hydride (NiMH), lithium-ion (Li-ion), etc.), solar cells, fuel cells, and the like.

The processor 32 may also be coupled to the GPS chipset 50, which may be configured to provide location information (e.g., longitude and latitude) regarding the current location of the node 30. It should be appreciated that the node 30 may acquire location information by way of any suitable location-determination method while remaining consistent with an example.

FIG. 12 is a block diagram of a computing system 1200 which may also be used to implement components of the system or be part of the UE 30. The computing system 1200 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 1200 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 1200 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that may not easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it may not access memory within another process's virtual address space unless memory sharing between the processes has been set up.

In addition, computing system 1200 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 1200. Such visual output may include text, graphics, animated graphics, and video. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 1200 may contain communication circuitry, such as for example a network adaptor 97, that may be used to connect computing system 1200 to an external communications network, such as network 12 of FIG. 11, to enable the computing system 1200 to communicate with other nodes (e.g., UE 30) of the network.

FIG. 13 illustrates a framework 1300 employed by a software application (e.g., computer code, a computer program) for providing observable virtual images. The framework 1300 may be hosted remotely. Alternatively, the framework 1300 may reside within the UE 30 shown in FIG. 11 and/or may be processed by the computing system 1200 shown in FIG. 12 and/or by the augmented reality system 600 of FIG. 10. The machine learning model 1310 is operably coupled to the stored training data 1320 in a database.

In an example, the training data 1320 may include attributes of thousands of objects. For example, the object(s) may be identified and/or associated with scenes, photographs/images, videos, regions (e.g., regions of interest), objects, eye positions, movements, pupil sizes, eye positions associated with various positions and/or the like. Attributes may include but are not limited to the size, shape, orientation, position of an object, i.e., within a scene, an eye, a gaze, etc. The training data 1320 employed by the machine learning model 1310 may be fixed or updated periodically. Alternatively, the training data 1320 may be updated in real-time based upon the evaluations performed by the machine learning model 1310 in a non-training mode. This is illustrated by the double-sided arrow connecting the machine learning model 1310 and stored training data 1320.

In operation, the machine learning model 1310 may evaluate attributes of images/videos obtained by hardware (e.g., of the augmented reality system 1000, UE 30, etc.). For example, the front camera 1016 and/or rear camera 1018 of the augmented reality system 1000 and/or camera 54 of the UE 30 shown in FIG. 11 senses and captures an image/video, such as for example approaching or departing objects, object interactions, eye movements tracked over time, correlations between eye movements and scene objects/events, positioning of images on a lens display, and/or other objects appearing in or around a bounding box of a software application. The attributes of the captured image (e.g., captured image of an object or person may then be compared with respective attributes of stored training data 1320 (e.g., prestored objects). The likelihood of similarity between each of the obtained attributes (e.g., of the captured image of an object(s)) and the stored training data 1320 (e.g., prestored objects) is given a determined confidence score. In one example, if the confidence score exceeds a predetermined threshold, the attribute is included in an image description that is ultimately communicated to the user via a user interface of a computing device (e.g., UE 30, computing system 1200). In another example, the description may include a certain number of attributes which exceed a predetermined threshold to share with the user. The sensitivity of sharing more or less attributes may be customized based upon the needs of the particular user.

FIG. 14 illustrates an example computer system 1400. In examples, one or more computer systems 1400 perform one or more steps of one or more methods described or illustrated herein. In particular embodiments, one or more computer systems 1400 provide functionality described or illustrated herein. In examples, software running on one or more computer systems 1400 performs one or more steps of one or more methods described or illustrated herein or provides functionality described or illustrated herein. Examples include one or more portions of one or more computer systems 1400. Herein, reference to a computer system may encompass a computing device, and vice versa, where appropriate. Moreover, reference to a computer system may encompass one or more computer systems, where appropriate.

This disclosure contemplates any suitable number of computer systems 1400. This disclosure contemplates computer system 1400 taking any suitable physical form. As example and not by way of limitation, computer system 1400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1400 may include one or more computer systems 1400; be unitary or distributed; span multiple locations; span multiple machines; span multiple data centers; or reside in a cloud, which may include one or more cloud components in one or more networks. Where appropriate, one or more computer systems 1400 may perform without substantial spatial or temporal limitation one or more steps of one or more methods described or illustrated herein. As an example, and not by way of limitation, one or more computer systems 1400 may perform in real time or in batch mode one or more steps of one or more methods described or illustrated herein. One or more computer systems 1400 may perform at different times or at different locations one or more steps of one or more methods described or illustrated herein, where appropriate.

In examples, computer system 1400 includes a processor 1402, memory 1404, storage 1406, an input/output (I/O) interface 1408, a communication interface 1410, and a bus 1412. Although this disclosure describes and illustrates a particular computer system having a particular number of particular components in a particular arrangement, this disclosure contemplates any suitable computer system having any suitable number of any suitable components in any suitable arrangement.

In examples, processor 1402 includes hardware for executing instructions, such as those making up a computer program. As an example and not by way of limitation, to execute instructions, processor 1402 may retrieve (or fetch) the instructions from an internal register, an internal cache, memory 1404, or storage 1406; decode and execute them; and then write one or more results to an internal register, an internal cache, memory 1404, or storage 1406. In particular embodiments, processor 1402 may include one or more internal caches for data, instructions, or addresses. This disclosure contemplates processor 1402 including any suitable number of any suitable internal caches, where appropriate. As an example, and not by way of limitation, processor 1402 may include one or more instruction caches, one or more data caches, and one or more translation lookaside buffers (TLBs). Instructions in the instruction caches may be copies of instructions in memory 1404 or storage 1406, and the instruction caches may speed up retrieval of those instructions by processor 1402. Data in the data caches may be copies of data in memory 1404 or storage 1406 for instructions executing at processor 1402 to operate on;

the results of previous instructions executed at processor 1402 for access by subsequent instructions executing at processor 1402 or for writing to memory 1404 or storage 1406; or other suitable data. The data caches may speed up read or write operations by processor 1402. The TLBs may speed up virtual-address translation for processor 1402. In particular embodiments, processor 1402 may include one or more internal registers for data, instructions, or addresses. This disclosure contemplates processor 1402 including any suitable number of any suitable internal registers, where appropriate. Where appropriate, processor 1402 may include one or more arithmetic logic units (ALUs); be a multi-core processor; or include one or more processors 1402. Although this disclosure describes and illustrates a particular processor, this disclosure contemplates any suitable processor.

In examples, memory 1404 includes main memory for storing instructions for processor 1402 to execute or data for processor 1402 to operate on. As an example, and not by way of limitation, computer system 1400 may load instructions from storage 1406 or another source (such as, for example, another computer system 1400) to memory 1404. Processor 1402 may then load the instructions from memory 1404 to an internal register or internal cache. To execute the instructions, processor 1402 may retrieve the instructions from the internal register or internal cache and decode them. During or after execution of the instructions, processor 1402 may write one or more results (which may be intermediate or final results) to the internal register or internal cache. Processor 1402 may then write one or more of those results to memory 1404. In particular embodiments, processor 1402 executes only instructions in one or more internal registers or internal caches or in memory 1404 (as opposed to storage 1406 or elsewhere) and operates only on data in one or more internal registers or internal caches or in memory 1404 (as opposed to storage 1406 or elsewhere). One or more memory buses (which may each include an address bus and a data bus) may couple processor 1402 to memory 1404. Bus 1412 may include one or more memory buses, as described below. In examples, one or more memory management units (MMUs) reside between processor 1402 and memory 1404 and facilitate accesses to memory 1404 requested by processor 1402. In particular embodiments, memory 1404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1404 may include one or more memories 1404, where appropriate. Although this disclosure describes and illustrates particular memory, this disclosure contemplates any suitable memory.

In examples, storage 1406 includes mass storage for data or instructions. As an example, and not by way of limitation, storage 1406 may include a hard disk drive (HDD), a floppy disk drive, flash memory, an optical disc, a magneto-optical disc, magnetic tape, or a Universal Serial Bus (USB) drive or a combination of two or more of these. Storage 1406 may include removable or non-removable (or fixed) media, where appropriate. Storage 1406 may be internal or external to computer system 1400, where appropriate. In examples, storage 1406 is non-volatile, solid-state memory. In particular embodiments, storage 1406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 1406 taking any suitable physical form. Storage 1406 may include one or more storage control units facilitating communication between processor 1402 and storage 1406, where appropriate. Where appropriate, storage 1406 may include one or more storages 1406. Although this disclosure describes and illustrates particular storage, this disclosure contemplates any suitable storage.

In examples, I/O interface 1408 includes hardware, software, or both, providing one or more interfaces for communication between computer system 1400 and one or more I/O devices. Computer system 1400 may include one or more of these I/O devices, where appropriate. One or more of these I/O devices may enable communication between a person and computer system 1400. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1408 for them. Where appropriate, I/O interface 1408 may include one or more device or software drivers enabling processor 1402 to drive one or more of these I/O devices. I/O interface 1408 may include one or more I/O interfaces 1408, where appropriate. Although this disclosure describes and illustrates a particular I/O interface, this disclosure contemplates any suitable I/O interface.

In examples, communication interface 1410 includes hardware, software, or both providing one or more interfaces for communication (such as, for example, packet-based communication) between computer system 1400 and one or more other computer systems 1400 or one or more networks. As an example, and not by way of limitation, communication interface 1410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1410 for it. As an example, and not by way of limitation, computer system 1400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1400 may include any suitable communication interface 1410 for any of these networks, where appropriate. Communication interface 1410 may include one or more communication interfaces 1410, where appropriate. Although this disclosure describes and illustrates a particular communication interface, this disclosure contemplates any suitable communication interface.

In particular embodiments, bus 1412 includes hardware, software, or both coupling components of computer system 1400 to each other. As an example and not by way of limitation, bus 1412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1412 may include one or more buses 1412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, computer readable medium or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed:

1. A system comprising:
a transparent combining optic comprising a holographic optical element (HOE), wherein the transparent combining optic is configured to:
diffract light to form a virtual image viewable from a non-pupil-forming eyebox, wherein the light is generated by an illumination source.

2. The system of claim 1, wherein the virtual image comprises at least one of: content defined by a distribution of the illumination source, or content defined by an encoding of the HOE.

3. The system of claim 1, wherein the illumination source comprises an array of illumination sources.

4. The system of claim 1, wherein the HOE comprises at least one of: a point-source hologram, an etendue expansion hologram, a set of multiplexed holograms, a layered stack of multiple holograms, or a patterned array of multiple holograms.

5. The system of claim 1, wherein the transparent combining optic comprises a photosensitive holographic film.

6. The system of claim 1, wherein the light propagates through at least one of: the transparent combining optic before being diffracted by the HOE, or free-space between the illumination source and the transparent combining optic.

7. The system of claim 1, wherein the light comprises non-replicating ray paths.

8. The system of claim 1, wherein the HOE comprises a point of illumination, and the illumination source is positioned at the point of illumination.

9. The system of claim 1, wherein the HOE comprises a point of illumination, and the light propagates through the point of illumination.

10. The system of claim 1, wherein a head-mounted device comprises the illumination source and the transparent combining optic.

11. The system of claim 1, wherein the illumination source is positioned outside of a field of view of a user wearing the head-mounted device.

12. A method comprising:
diffracting light received at a first side of a transparent combining optic, wherein the transparent combining optic comprises a holographic optical element (HOE), and wherein the light is generated by an illumination source; and
forming a virtual image viewable from a non-pupil-forming eyebox, wherein the virtual image is viewable from the first side of the transparent combining optic.

13. The method of claim 12, further comprising: securing the illumination source to a frame of a head-mounted device.

14. The method of claim 12, wherein the virtual image is positioned to overlay a scene viewable through the transparent combining optic.

15. The method of claim 12, further comprising:
multiplexing, by the transparent combining optic, light from a second illumination source to generate a second virtual image positioned to overlay a scene.

16. A non-transitory computer readable medium comprising computer-executable instructions,
which when executed cause:
emitting light generated by an illumination source towards a first side of a transparent combining optic comprising a holographic optical element (HOE);
facilitating diffraction of the light received at the first side of the transparent combining optic; and
forming a virtual image viewable from a non-pupil-forming eyebox, wherein the virtual image is viewable from the first side of the transparent combining optic.

17. The non-transitory computer readable medium of claim 16, wherein the instructions, when executed, further cause:
emitting a second object beam from a second illumination source towards the first side of the transparent combining optic to generate a multiplexed hologram.

18. The non-transitory computer readable medium of claim 16, wherein the instructions, when executed, further cause:
positioning the virtual image to overlay a scene viewable through the transparent combining optic.

19. The non-transitory computer readable medium of claim 16, wherein the virtual image comprises at least one of: content defined by a distribution of the illumination source, or content defined by an encoding of the HOE.

20. The non-transitory computer readable medium of claim 16, wherein the HOE comprises at least one of: a point-source hologram, an etendue expansion hologram, a set of multiplexed holograms, a layered stack of multiple holograms, or a patterned array of multiple holograms.
